(19) United States
(12) Patent Application Publication
(10) Pub. No.: US 2026/0072619 A1
(43) Pub. Date: Mar. 12, 2026

(54) STORAGE SYSTEM

(71) Applicant: Hitachi Vantara, Ltd., Yokohama-shi (JP)

(72) Inventors: Kentaro SHIMADA, Tokyo (JP); Nobuhiro YOKOI, Tokyo (JP)

(73) Assignee: Hitachi Vantara, Ltd., Yokohama-shi (JP)

(21) Appl. No.: 19/078,028

(22) Filed: Mar. 12, 2025

(30) Foreign Application Priority Data
Sep. 6, 2024 (JP) 2024-153952

(51) Int. Cl. G06F 3/06

(52) U.S. Cl. CPC G06F 3/0683; G06F 3/0604; G06F 3/0655

(57) ABSTRACT

A storage system includes a first processing mode in which a request from a host machine received by a first protocol chip is stored in a first memory included in the same controller as the one which includes the first protocol chip, and a result of processing the request from the host machine is read out from the first memory, and a second processing mode in which a request from the host machine is stored in a second memory included in a controller different from the first protocol chip, and a response of the result of processing the request from the host machine is read out from the second memory.

### CLAIM OF PRIORITY

The present application claims priority from Japanese patent application JP 2024-153952 filed on Sep. 6, 2024, the content of which is hereby incorporated by reference into this application.

### BACKGROUND OF THE INVENTION

### 1. Field of the Invention

The present invention relates to a storage system that stores/outputs data in accordance with a request from a host machine.

### 2. Description of the Related Art

In a storage system that is connected to a host machine and stores/outputs data according to a request from the host machine, high reliability and high availability are required to support processing performed by the host machine. Therefore, in the storage system, in addition to not losing the stored data due to a fault or the like, it is required to keep access from the host machine to the data stored in the storage system.

For example, JP 2024-60523 A discloses an example of a storage system that includes an individual address translation unit between a protocol chip and each processor and keeps access to data from a host machine by transmitting a request received by the protocol chip from the host machine to a processor that continues operation even if any processor stops operating. However, in this case, when any of the processors stops operating, it is necessary to instruct the protocol chip to transmit a request from the host machine received by the protocol chip to the processor that continues operating. In addition, between each protocol chip and each processor, an individual address translation unit that translates an address used by each protocol chip into an address used by each processor is required for each processor, that is, a total of the number of processors.

### SUMMARY OF THE INVENTION

A technology capable of keeping access to data from a host machine even when a processor or a memory of a controller in the storage system stops operating due to a fault or the like without requiring an individual address translation unit that translates an address used by a protocol chip into an address used by each processor for each processor is desired.

An aspect of the present invention is a storage system that is connected to a host machine and stores/outputs data according to a request from the host machine. The storage system includes a plurality of controllers. A first controller of the plurality of controllers includes: a first protocol chip that is connected to the host machine and performs protocol processing of data transmission with the host machine; a first processor that controls the storage system; and a first memory that is connected to the first processor and stores data necessary for controlling the storage system. A second controller different from the first controller among the plurality of controllers includes: a second processor that controls the storage system; and a second memory that is connected to the second processor and stores data necessary for controlling the storage system. The storage system further includes a mutual address translation unit that mutually translates an address used by the first processor and an address used by the second processor. A processing mode of the storage system includes a first processing mode and a second processing mode. In the first processing mode, the first protocol chip stores a request received from the host machine in the first memory, the first processor processes the request from the host machine stored in the first memory, and stores a response of a result of processing the request from the host machine in the first memory, and the first protocol chip reads out, from the first memory, the response of the result of processing the request from the host machine, and transmits the response to the host machine. In the second processing mode, the first protocol chip stores a request received from the host machine in the second memory through the mutual address translation unit, the second processor processes the request from the host machine stored in the second memory, and stores a response of a result of processing the request from the host machine in the second memory, and the first protocol chip reads out, from the second memory, the response of the result of processing the request from the host machine through the mutual address translation unit and transmits the response to the host machine.

According to the present invention, the first processor and the first memory can be replaced with the second processor and the second memory to process the request from the host machine received by the protocol chip, and even if the first processor stops operating or the first memory becomes unavailable due to a fault, the request from the host machine can be continuously responded.

### BRIEF DESCRIPTION OF THE DRAWINGS

FIG. 1 is an example of a first configuration of a storage system;

FIG. 2 is an example of a processing sequence of processing a Read request from a host machine in a first processing mode in the example of the first configuration;

FIG. 3 is an example of a processing sequence of processing a Write request from the host machine in the first processing mode in the example of the first configuration;

FIG. 4 is an example of a processing sequence of processing a Read request from the host machine in a second processing mode in the example of the first configuration;

FIG. 5 is an example of a processing sequence of processing a Write request from the host machine in the second processing mode in the example of the first configuration;

FIG. 6 is an example of a second configuration of the storage system;

FIG. 7 is an example of a processing sequence of processing a Read request from the host machine in a first processing mode in the example of the second configuration;

FIG. 8 is an example of a processing sequence of processing a Write request from the host machine in the first processing mode in the example of the second configuration;

FIG. 9 is an example of a processing sequence of processing a Read request from the host machine in a second processing mode in the example of the second configuration;

FIG. 10 is an example of a processing sequence of processing a Write request from the host machine in the second processing mode in the example of the second configuration;

FIG. 11 is an example of a third configuration of the storage system;

FIG. 12 is an example of a processing sequence of processing a Read request from a host machine in a first processing mode in the example of a third configuration;

FIG. 13 is an example of a processing sequence of processing a Write request from the host machine in the first processing mode in the example of the third configuration;

FIG. 14 is an example of a processing sequence of processing a Read request from a host machine in a second processing mode in the example of the third configuration;

FIG. 15 is an example of a processing sequence of processing a Write request from the host machine in the second processing mode in the example of the third configuration;

FIG. 16 is an example of a flowchart of switching processing for switching from the first processing mode to the second processing mode in the example of the second configuration;

FIG. 17 is an example in which translation of each of a memory address translation unit and a mutual address translation unit is illustrated in an address space in the example of the first configuration;

FIG. 18 is an example of a flowchart of switching processing for switching from the first processing mode to the second processing mode in the example of the first configuration;

FIG. 19 is an example of a flowchart of processing for storing information for notifying that a request from the host machine has been stopped in the first processing mode;

FIG. 20 is an example of a flowchart of processing for notifying that a request from the host machine has been stopped in the second processing mode;

FIG. 21 is another example of a processing sequence of processing a Read request from the host machine in the first processing mode in the example of the first configuration;

FIG. 22 is another example of a processing sequence of processing a Write request from the host machine in the first processing mode in the example of the first configuration;

FIG. 23 is another example of a flowchart of switching processing for switching from the first processing mode to the second processing mode in the example of the first configuration; and

FIG. 24 is an example of a flowchart for processing a request from the host machine remaining in the first processing mode after switching from the first processing mode to the second processing mode in the example of the first configuration.

### DESCRIPTION OF THE PREFERRED EMBODIMENTS

### First Embodiment

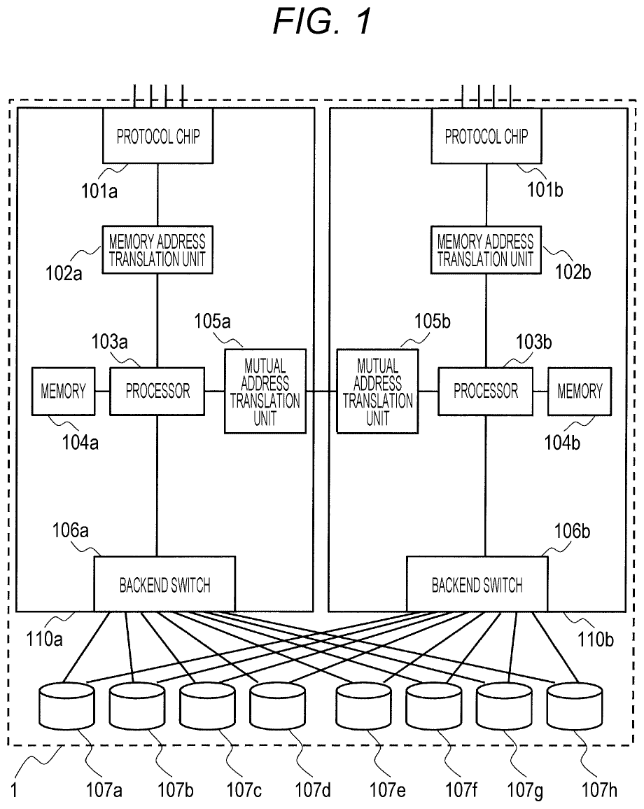

A first embodiment will be described with reference to FIGS. 1, 2, 3, 4, 5, 17, and 18.

FIG. 1 is an example of a configuration of a storage system according to the first embodiment.

In FIG. 1, a storage system 1 includes two controllers 110a and 110b and eight storage devices 107a to 107h.

The controller 110a includes one protocol chip 101a, a memory address translation unit 102a, a processor 103a, a memory 104a, a mutual address translation unit 105a, and a backend switch 106a.

The controller 110b includes one protocol chip 101b, a memory address translation unit 102b, a processor 103b, a memory 104b, a mutual address translation unit 105b, and a backend switch 106b.

The protocol chips 101a and 101b are connected to a host machine (not illustrated), and performs protocol processing of data transmission between the host machine and the storage system 1. One example of a protocol of data transmission between the host machine and the storage system 1 is Fibre Channel. Another example of the protocol of data transmission between the host machine and the storage system 1 is iSCSI (Internet Small Computer System Interface).

Note that, in FIG. 1, the protocol chips 101a and 101b are provided in the controllers 110a and 110b, respectively, but the number of protocol chips in the controller is not limited to one and can be any number.

The memory address translation unit 102a has a function of translating an address indicating the memory 104a used by the protocol chip 101a to store a request from the host machine into an address indicating the memory 104b, and translating an address indicating the memory 104a used by the protocol chip 101a to read out a response of the result of processing the request from the host machine into an address indicating the memory 104b.

The memory address translation unit 102b has a function of translating an address indicating the memory 104b used by the protocol chip 101b to store a request from the host machine into an address indicating the memory 104a, and translating an address indicating the memory 104b used by the protocol chip 101b to read out a response of the result of processing the request from the host machine into an address indicating the memory 104a.

In FIG. 1, the memory address translation units 102a and 102b are provided in the controllers 110a and 110b, respectively, but the number of memory address translation units in the controller is not limited to one and can be any number. Furthermore, in FIG. 1, the memory address translation units 102a and 102b are connected to the protocol chips 101a and 101b, respectively, but the number of memory address translation units may be smaller than the number of protocol chips. In a case where the number of memory address translation units is smaller than the number of protocol chips, one or more protocol chips may be connected to one memory address translation unit.

The processors 103a and 103b are connected to the memories 104a and 104b, respectively, and control the storage system 1 by executing the instruction code stored in the memory 104a or 104b.

The memories 104a and 104b store instruction codes executed by the processors 103a and 103b, respectively, and also store data necessary for executing the instruction codes. In addition, data to be stored in the storage devices 107a to 107h transmitted by the host machine through the protocol chip 101a or 101b may be temporarily stored, or data read out from the storage devices 107a to 107h and transmitted to the host machine through the protocol chip 101a or 101b may be temporarily stored.

In particular, the memory 104a or the memory 104b stores a request from the host machine such as a data read (Read) request and a data store (Write) request which are received by the protocol chip from the host machine with respect to the storage system, and also stores a response of the result of processing the request from the host machine by the processor 103a or 103b. An example of the memories 104a and 104b is a dynamic random access memory (DRAM).

In FIG. 1, the processors 103a and 103b and the memories 104a and 104b are provided in the controllers 110a and 110b, respectively, but the number of processors and memories in the controller is not limited to one and can be any number.

The mutual address translation units 105a and 105b have a function of mutually translating addresses used by the processor 103a and the processor 103b. The processor 103a can access an arbitrary address of the memory 104b via the mutual address translation units 105a and 105b. Similarly, the processor 103b can access an arbitrary address of the memory 104a via the mutual address translation units 105b and 105a.

Furthermore, the protocol chip 101a can store a request from the host machine in the memory 104b and read out a response of the result of processing the request from the host machine from the memory 104b via the memory address translation unit 102a, the processor 103a, and the mutual address translation units 105a and 105b. Similarly, the protocol chip 101b can store a request from the host machine in the memory 104a and read out a response of the result of processing the request from the host machine from the memory 104a via the memory address translation unit 102b, the processor 103b, and the mutual address translation units 105b and 105a.

In FIG. 1, the mutual address translation units 105a and 105b are provided in the controllers 110a and 110b, respectively, but the number of mutual address translation units in the controller is not limited to one and can be any number. In particular, in FIG. 1, the mutual address translation units 105a and 105b are separately provided in the controllers 110a and 110b, respectively. However, the mutual address translation units 105a and 105b may be collectively provided as one mutual address translation unit, and may be provided in only one of the controllers 110a and 110b.

The backend switches 106a and 106b connect each of the processors 103a and 103b to eight storage devices 107a to 107h, and perform switching processing of data transmission between the processors 103a and 103b and the eight storage devices 107a to 107h according to a protocol of data transmission between the processors 103a and 103b and the storage devices 107a to 107h.

One example of a protocol of data transmission used between the processors 103a and 103b and the storage devices 107a to 107h is SAS(Serial Attached Small computer system interface). Another example of the protocol of data transmission used between the processors 103a and 103b and the storage devices 107a to 107h is NVMe (Non-Volatile Memory express). The processing of these protocols of data transmission may be directly performed by the processors 103a and 103b, or may be performed by providing a dedicated protocol processing chip (not illustrated) between the processors 103a and 103b and the backend switches 106a and 106b.

In FIG. 1, the backend switches 106a and 106b are provided in the controllers 110a and 110b, respectively, but the number of backend switches in the controller is not limited to one and can be any number.

The storage devices 107a to 107h store and hold data transmitted by the host machine to be stored in the storage system 1. One example of the storage devices 107a to 107b is a solid state device (SSD) which uses a flash memory as its storage element. Another example of the storage devices 107a to 107b is a hard disk drive (HDD) using a magnetic disk as its storage media. In FIG. 1, the storage system 1 includes eight storage devices 107a to 107h, but the number of storage devices is not limited to eight and can be any number.

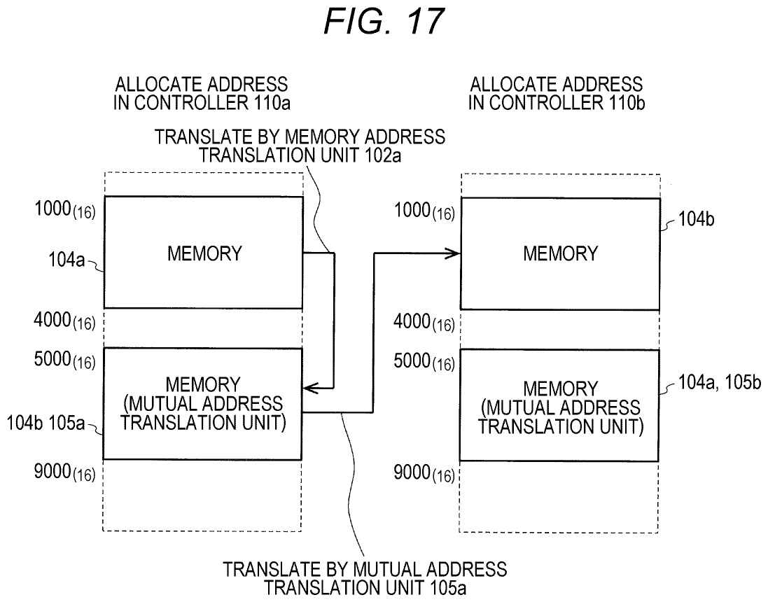

An example of address translation of the memory address translation unit 102a or 102b and the mutual address translation unit 105a or 105b will be further described with reference to FIG. 17.

FIG. 17 illustrates an example of address assignment in the controllers 110a and 110b. In the example of FIG. 17, in the controller 110a, the memory 104a has address assignment from 1000(16) (where (16) denotes a hexadecimal number, and the same shall apply hereafter) to 4000(16).

In the controller 110a, the address spaces from 5000(16) to 9000(16) are assigned to the memory 104b. At this time, since the memory 104b itself is not in the controller 110a but in the controller 110b, the mutual address translation unit 105a actually has the address assignment from 5000(16) to 9000(16) in the controller 110a.

Similarly, in the controller 110b, the memory 104b has the address assignment from 1000(16) to 4000(16). In the controller 110b, the address spaces from 5000(16) to 9000(16) are assigned to the memory 104a. At this time, since the memory 104a itself is not in the controller 110b but in the controller 110a, the mutual address translation unit 105b actually has the address assignment from 5000(16) to 9000(16) in the controller 110b.

In the example of FIG. 17, in the controller 110a, when the function of translating the address of the memory 104a into the address indicating the memory 104b in the memory address translation unit 102a is effective, the memory address translation unit 102a translates the access request to the addresses from 1000(16) to 4000(16) of the memory 104a transmitted from the protocol chip 101a into the access request to the addresses from 5000(16) to 9000(16) indicating the memory 104b. The operation of the memory address translation unit 102b in the controller 110b is similar if the controller 110a is replaced with the controller 110b, the memory 104a is replaced with the memory 104b, and the memory address translation unit 102a is replaced with the memory address translation unit 102b.

In addition, in a case where the memory 104b is accessed from the inside of the controller 110a, since the memory 104b itself is in the controller 110b, the memory is accessed from the inside of the controller 110a through the mutual address translation unit 105a. Therefore, in a case where there is an access request of the addresses from 5000(16) to 9000(16) in the controller 110a, the mutual address translation unit 105a is actually accessed.

In a case where an access request of the addresses 5000(16) to 9000(16) is received from the inside of the controller 110a, the mutual address translation unit 105a translates the addresses from 5000(16) to 9000(16) of the access request into addresses 1000(16) to 4000(16) of the memory 104b in the controller 110b, and transmits the access request to the controller 110b through the mutual address translation unit 105b. By doing so, the memory 104b itself in the controller 110b can be accessed from the inside of the controller 110a.

The same applies to a case where the memory 104a itself in the controller 110a is accessed from the inside of the controller 110b if the controller 110a is replaced with the controller 110b (110b is replaced with 110a), the memory 104b is replaced with the memory 104a, and the mutual address translation unit 105a is replaced with the mutual address translation unit 105b (105b is replaced with 105a).

In the first processing mode, the storage system 1 of the present embodiment stores a Read request and a Write request from the host machine received by the protocol chip 101a in the memory 104a included in the same controller 110a as the one which includes the protocol chip 101a, and reads out, from the memory 104a, a response of the result of processing the request from the host machine.

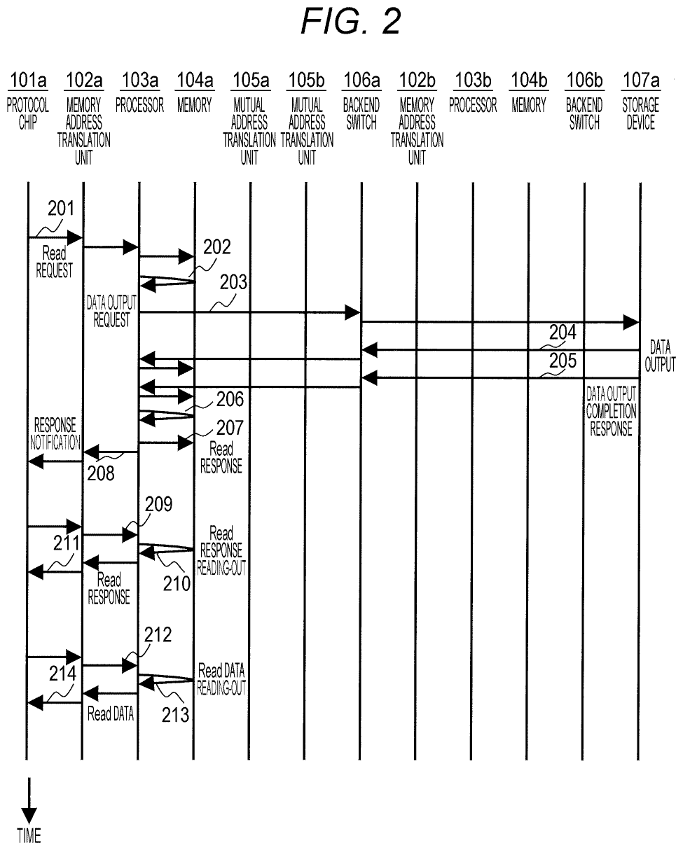

In addition, in the second processing mode, the storage system 1 stores a Read request and a Write request from the host machine received by the protocol chip 101a in the memory 104b included in the controller 110b different from the one which includes the protocol chip 101a, and similarly reads out, from the memory 104b, a response of the result of processing the request from the host machine. A sequence of this operation will be described with reference to FIGS. 2, 3, 4, and 5.

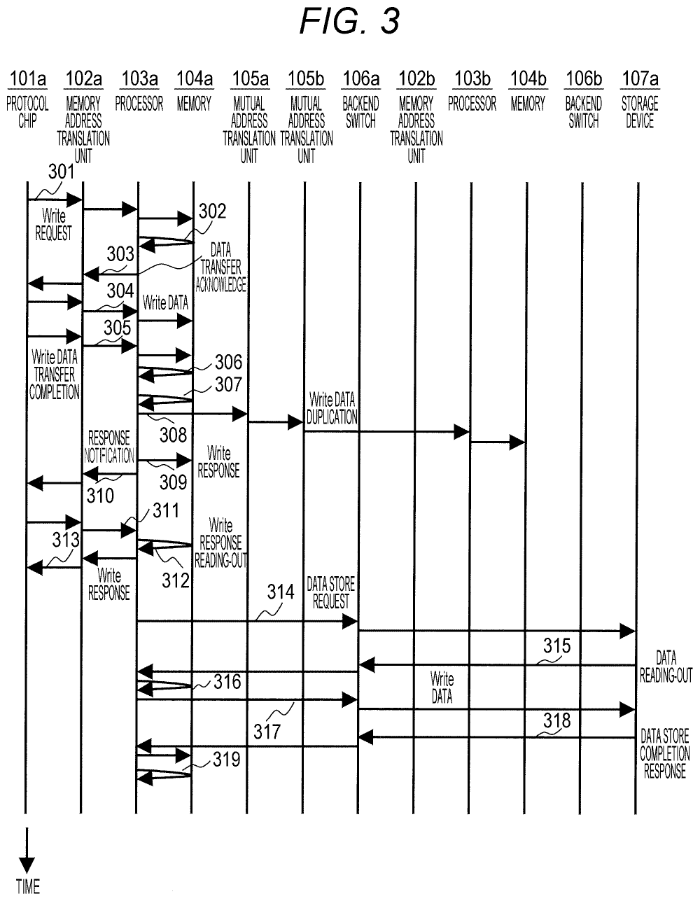

FIG. 2 is an example of a processing sequence in a case where the storage system 1 receives a Read request from the host machine in the first processing mode. In FIG. 2, each vertical line indicates a time order of a request or a response transmitted or received by a part described above. It is assumed that the time progresses from the top to the bottom in the drawing (the same applies to FIGS. 3, 4, and 5 below).

In FIG. 2, when receiving a Read request from a host machine (not illustrated), the protocol chip 101a designates an address indicating the memory 104a as a storing destination and transmits the request from the host machine to the memory address translation unit 102a (201).

In the first processing mode, by setting the address translation function of the memory address translation unit 102a to be ineffective, the memory address translation unit 102a transmits the request, which is transmitted by the protocol chip 101a from the host machine in which the address of the memory 104a is designated as the storing destination, to the processor 103a without performing address translation as it is.

The processor 103a stores, in the memory 104a, the request from the host machine, which is transmitted from the memory address translation unit 102a and designated with the address of the memory 104a as the storing destination, according to the designated address. The process of storing into the memory 104a by the processor 103a may be performed by causing the processor 103a to execute some kind of instruction code, or may be performed by providing a hardware mechanism for automatically storing in the memory 104a according to a designated address in the processor 103a.

Next, the processor 103a reads out the request, which is from the host machine transmitted from the protocol chip 101a, from the memory 104a and starts the processing (202). If the request from the host machine read out from the memory 104a is a Read request, the processor 103a determines in which of the storage devices 107a to 107h the requested data is held, generates a data output request to the storage device, that is, the storage device 107a in the example of FIG. 2, and transmits the data output request via the backend switch 106a (203).

The storage device 107a acquires the requested data from an internal storage element or a storage media, and stores the data in the memory 104a via the backend switch 106a and the processor 103a (204). Furthermore, the storage device 107a generates a data output completion response indicating that the requested data has been successfully stored in the memory 104a, and stores the data output completion response in the memory 104a similarly via the backend switch 106a and the processor 103a (205).

The process of storing the data from the storage device 107a and the data output completion response via the processor 103a into the memory 104a may be performed by causing the processor 103a to execute some kind of instruction code, or may be performed by providing a hardware mechanism that automatically stores the data in the memory 104a in the processor 103a.

Next, the processor 103a reads out the data output completion response written from the storage device 107a into the memory 104a from the memory 104a (206). In accordance with the read-out data output completion response, the processor 103a generates a Read response to be transmitted to the host machine, and stores the Read response in the memory 104a (207). Thereafter, the processor 103a generates a response notification notifying the protocol chip 101a that the Read response has been stored in the memory 104a, and transmits the response notification to the protocol chip 101a via the memory address translation unit 102a (208).

When receiving the response notification from the processor 103a, the protocol chip 101a designates an address indicating the memory 104a as a source of read out, and transmits a read out request of the Read response to the memory address translation unit 102a. In the first processing mode, by setting the address translation function of the memory address translation unit 102a to be ineffective, the memory address translation unit 102a transmits the read out request of the Read response, which is transmitted by the protocol chip 101a and in which the address of the memory 104a is designated as the source of read out, to the processor 103a without performing address translation as it is (209). When receiving the Read response read out request from the protocol chip 101a, the processor 103a reads out the Read response from the memory 104a (210) and transmits the Read response to the protocol chip 101a via the memory address translation unit 102a (211).

The Read response read out from the memory 104a by the processor 103a according to the Read response read out request from the protocol chip 101a may be performed by causing the processor 103a to execute some kind of instruction code, or may be performed by providing a hardware mechanism that automatically reads out from the memory 104a in the processor 103a.

When receiving the Read response from the processor 103a, the protocol chip 101a transmits a Read data read out request for extracting Read data from the memory 104a to the processor 103a via the memory address translation unit 102a according to the response content (212).

In accordance with the transmitted Read data read out request, the processor 103a reads out the Read data (213), and transmits the read-out Read data to the protocol chip 101a via the memory address translation unit 102a (214). The Read data read out from the memory 104a by the processor 103a according to the Read data read out request from the protocol chip 101a may be performed by causing the processor 103a to execute some kind of instruction code, or may be performed by providing a hardware mechanism that automatically reads out data from the memory 104a in the processor 103a. When receiving the Read data from the processor 103a, the protocol chip 101a transmits the Read data to a host machine (not illustrated).

FIG. 3 is an example of a processing sequence in a case where the storage system 1 receives a Write request from the host machine in the first processing mode.

In FIG. 3, when receiving a Write request from a host machine (not illustrated), the protocol chip 101a designates an address indicating the memory 104a as a storing destination and transmits the request from the host machine to the memory address translation unit 102a (301). In the first processing mode, by setting the address translation function of the memory address translation unit 102a to be ineffective, the memory address translation unit 102a transmits the request, which is transmitted by the protocol chip 101a from the host machine in which the address of the memory 104a is designated as the storing destination, to the processor 103a without performing address translation as it is.

The processor 103a stores, in the memory 104a, the request from the host machine, which is transmitted from the memory address translation unit 102a and designated with the address of the memory 104a as the storing destination, according to the designated address. The process of storing into the memory 104a by the processor 103a may be performed by causing the processor 103a to execute some kind of instruction code, or may be performed by providing a hardware mechanism for automatically storing in the memory 104a according to a designated address in the processor 103a.

Next, the processor 103a reads out the request, which is from the host machine transmitted from the protocol chip 101a, from the memory 104a and starts the processing (302). If the request from the host machine read out from the memory 104a is a Write request, the processor 103a prepares to receive the Write data and transmits a transfer acknowledge of the Write data to the protocol chip 101a via the memory address translation unit 102a (303).

The protocol chip 101a that has received the Write data transfer acknowledge transmits the Write data transfer acknowledge to the host machine, and receives the Write data from the host machine. The protocol chip 101a stores the Write data received from the host machine in the memory 104a via the memory address translation unit 102a and the processor 103a (304).

Further, when receiving a signal indicating Write data transfer completion from the host machine, the protocol chip 101a stores the Write data transfer completion in the memory 104a similarly via the memory address translation unit 102a and the processor 103a (305). The process of storing the Write data and the Write data transfer completion into the memory 104a via the processor 103a may be performed by causing the processor 103a to execute some kind of instruction code, or may be performed by providing a hardware mechanism for automatically storing the data in the memory 104a in the processor 103a.

Next, the processor 103a reads out and checks the Write data transfer completion stored in the memory 104a (306). Thereafter, the processor 103a reads out the Write data from the memory 104a (307), and transmits the Write data to be stored in the memory 104b via the mutual address translation units 105a and 105b and the processor 103b (308).

This is because the Write data is to be duplicated in the memory 104a and the memory 104b, and even if the one of memory 104a or 104b becomes inaccessible due to a fault or stopping power supply, or the processor 103a or 103b stops operating, the Write data received from the host machine is not lost.

In addition, the process of storing the Write data in the memory 104b via the processor 103b may be performed by causing the processor 103b to execute some kind of instruction code, or may be performed by providing a hardware mechanism for automatically storing the Write data in the memory 104b in the processor 103b.

When the process of duplicating the Write data is completed, the processor 103a generates a Write response and stores the Write response in the memory 104a (309). Thereafter, the processor 103a generates a response notification notifying the protocol chip 101a that the Write response has been stored in the memory 104a, and transmits the response notification to the protocol chip 101a via the memory address translation unit 102a (310).

When receiving the response notification from the processor 103a, the protocol chip 101a designates an address indicating the memory 104a as a source of read out, and transmits a read out request of the Write response to the memory address translation unit 102a. In the first processing mode, by setting the address translation function of the memory address translation unit 102a to be ineffective, the memory address translation unit 102a transmits the read out request of the Write response, which is transmitted by the protocol chip 101a and in which the address of the memory 104a is designated as the source of read out, to the processor 103a without performing address translation as it is (311). When receiving the Write response read out request from the protocol chip 101a, the processor 103a reads out the Write response from the memory 104a (312) and transmits the Write response to the protocol chip 101a via the memory address translation unit 102a (313).

The Write response read out from the memory 104a by the processor 103a according to the Write response read out request from the protocol chip 101a may be performed by causing the processor 103a to execute some kind of instruction code, or may be performed by providing a hardware mechanism that automatically reads out from the memory 104a in the processor 103a. When receiving the Write response from the processor 103a, the protocol chip 101a notifies the host machine that the Write processing has been completed.

Next, the processor 103a determines the storage devices 107a to 107h in which the Write data stored in the memory 104a is to be stored. In FIG. 3, it is assumed that the processor 103a determines to store the Write data stored in the memory 104a in the storage device 107a. Therefore, the processor 103a generates a data store request and transmits the data store request to the storage device 107a via the backend switch 106a (314).

The storage device 107a that has received the data store request transmits a data read request of the Write data to the processor 103a via the backend switch 106a (315). When receiving the data read request, the processor 103a reads out the Write data from the memory 104a (316), transmits the Write data to the storage device 107a via the backend switch 106a to store the Write data (317).

The reading-out of the Write data from the memory 104a by the processor 103a according to the data read out request of the Write data from the storage device 107a may be performed by causing the processor 103a to execute some kind of instruction code, or may be performed by providing a hardware mechanism for automatically reading out the Write data from the memory 104a in response to the read out request of the Write data in the processor 103a.

When receiving Write data, the storage device 107a stores the received Write data in an internal storage element or storage media. When storing the Write data into the internal storage element or storage media is completed, the storage device 107a generates a data store completion response and stores the data store completion response in the memory 104a via the backend switch 106a and the processor 103a (318).

The process of storing the data store completion response into the memory 104a via the processor 103a may be performed by causing the processor 103a to execute some kind of instruction code, or may be performed by providing a hardware mechanism for automatically storing the data in the memory 104a in the processor 103a. Finally, the processor 103a reads out the data store completion response from the memory 104a and checks it (319).

The above is the operation in the storage system 1 when there is a Read request or a Write request from the host machine in the first processing mode in which the request from the host machine and the response of the result of processing the request from the host machine are stored in the memory 104a.

In a case where the memory 104a cannot be accessed due to a fault or stopping power supply, or the processor 103a stops operating and cannot store or read out into or from the memory 104a, a second processing mode in which storing a request from the host machine and a response of the result of processing the request from the host machine in the memory 104b is applied instead of the memory 104a. By applying the second processing mode, it is possible to continue the processing of the request from the host machine even when the memory 104a cannot be accessed due to a fault or stopping power supply, or the processor 103a stops operating and cannot store or read out into or from the memory 104a.

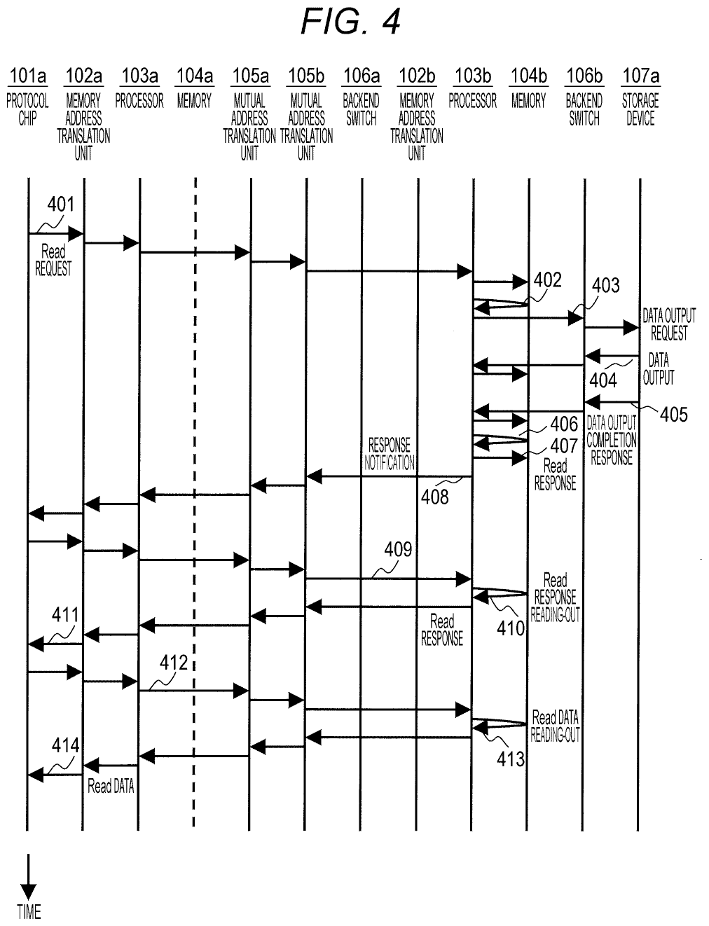

FIG. 4 is an example of a processing sequence in the storage system 1 when a Read request is received from the host machine in a case where the second processing mode is applied.

In FIG. 4, when receiving a Read request from a host machine (not illustrated), the protocol chip 101a designates an address indicating the memory 104a as a storing destination and transmits the request from the host machine to the memory address translation unit 102a (401). In the second processing mode, by setting the address translation function of the memory address translation unit 102a to be effective, the memory address translation unit 102a translates the address associated with the request from the host machine transmitted by the protocol chip 101a designating the memory 104a as the storing destination into the address designating the memory 104b, and transmits the request from the host machine to the processor 103a.

The processor 103a stores, in the memory 104b, the request from the host machine, which is transmitted from the memory address translation unit 102a and designated with the address of the memory 104b as the storing destination, via the mutual address translation units 105a and 105b and the processor 103b according to the designated address.

The process of storing, in the memory 104b by the processor 103a, the request from the host machine designated with the address of the memory 104b as the storing destination via the mutual address translation units 105a and 105b and the processor 103b according to the designated address can be performed by providing a hardware mechanism in the processor 103a to automatically transmit the request to the mutual address translation unit 105a according to the designated address even when the processor 103a stops the operating of the request from the host machine although the processor 103a stops the operating of the request from the host machine in the second processing mode.

Next, the processor 103b reads out, from the memory 104b, the request from the host machine transmitted from the protocol chip 101a and starts the processing (402). If the request from the host machine read out from the memory 104b is a Read request, the processor 103b determines in which of the storage devices 107a to 107h the requested data is held, generates a data output request to the storage device, that is, the storage device 107a in the example of FIG. 4, and transmits the data output request via the backend switch 106b (403).

The storage device 107a acquires the requested data from an internal storage element or a storage media, and stores the data in the memory 104b via the backend switch 106b and the processor 103b (404). Furthermore, the storage device 107a generates a data output completion response indicating that the requested data has been successfully stored in the memory 104b, and stores the data output completion response in the memory 104b similarly via the backend switch 106b and the processor 103b (405).

The process of storing the data from the storage device 107a and the data output completion response via the processor 103b into the memory 104b may be performed by causing the processor 103b to execute some kind of instruction code, or may be performed by providing a hardware mechanism that automatically stores the data in the memory 104b in the processor 103b.

Next, the processor 103b reads out the data output completion response written from the storage device 107a into the memory 104b from the memory 104b (406). In accordance with the read-out data output completion response, the processor 103b generates a Read response to be transmitted to the host machine, and stores the Read response in the memory 104b (407).

Thereafter, the processor 103b generates a response notification notifying the protocol chip 101a that the Read response has been stored in the memory 104b, and transmits the response notification to the protocol chip 101a via the mutual address translation units 105b and 105a, the processor 103a, and the memory address translation unit 102a (408).

When receiving the response notification from the processor 103b, the protocol chip 101a designates an address indicating the memory 104a as a source of read out, and transmits a read out request of the Read response to the memory address translation unit 102a. In the second processing mode, by setting the address translation function of the memory address translation unit 102a to be effective, the memory address translation unit 102a translates the address designating the memory 104a as the read-out source into the address designating the memory 104b for the read out request of the Read response transmitted by the protocol chip 101a, and transmits the address to the processor 103a.

The processor 103a transmits, to the processor 103b, the read out request of the Read response, which is transmitted from the memory address translation unit 102a and designated with the address of the memory 104b as the read-out source, via the mutual address translation units 105a and 105b according to the designated address (409).

When receiving the Read response read out request from the protocol chip 101a, the processor 103b reads out the Read response from the memory 104b (410) and transmits the Read response to the protocol chip 101a via the mutual address translation units 105b and 105a, the processor 103a, and the memory address translation unit 102a (411). The Read response read out from the memory 104b by the processor 103b according to the Read response read out request from the protocol chip 101a may be performed by causing the processor 103b to execute some kind of instruction code, or may be performed by providing a hardware mechanism that automatically reads out from the memory 104b in the processor 103b.

When receiving the Read response from the processor 103b, the protocol chip 101a transmits a Read data read out request for extracting Read data from the memory 104b to the processor 103b via the memory address translation unit 102a, the processor 103a, the mutual address translation units 105a and 105b according to the response content (412).

In accordance with the transmitted Read data read out request, the processor 103b reads out the Read data (413), and transmits the read-out Read data to the protocol chip 101a via the mutual address translation units 105b and 105a, the processor 103a, and the memory address translation unit 102a (414).

The Read data read out from the memory 104b by the processor 103b according to the Read data read out request from the protocol chip 101a may be performed by causing the processor 103b to execute some kind of instruction code, or may be performed by providing a hardware mechanism that automatically reads out data from the memory 104b in the processor 103b. When receiving the Read data from the processor 103b, the protocol chip 101a transmits the Read data to a host machine (not illustrated).

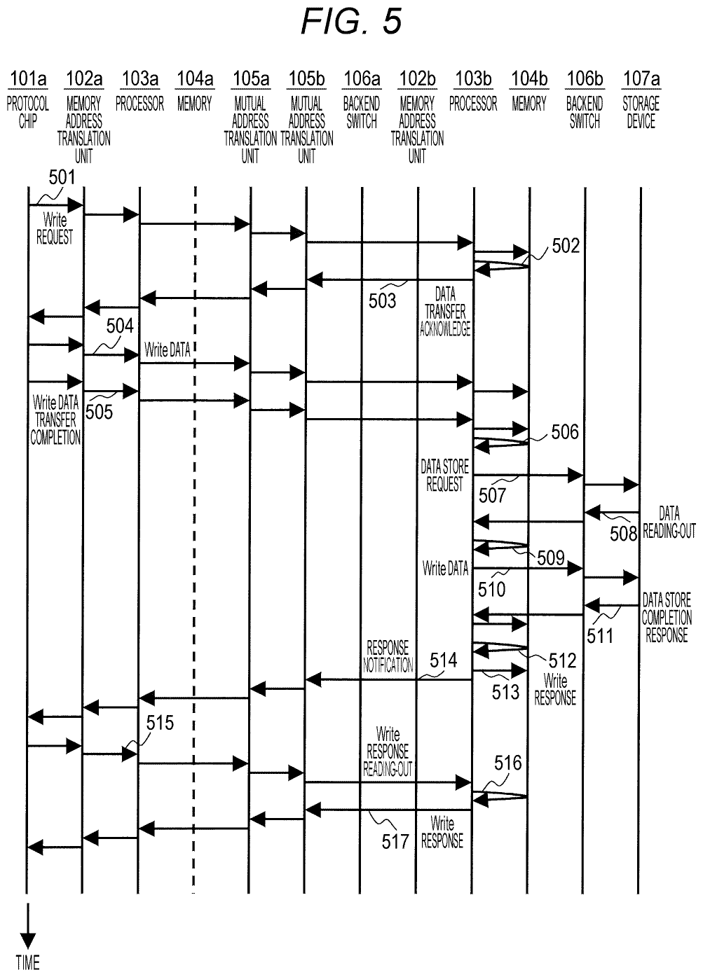

FIG. 5 is an example of a processing sequence in a case where the storage system 1 receives a Write request from the host machine in the second processing mode.

In FIG. 5, when receiving a Write request from a host machine (not illustrated), the protocol chip 101a designates an address indicating the memory 104a as a storing destination and transmits the request from the host machine to the memory address translation unit 102a (501). In the second processing mode, by setting the address translation function of the memory address translation unit 102a to be effective, the memory address translation unit 102a translates the address associated with the request from the host machine transmitted by the protocol chip 101a designating the memory 104a as the storing destination into the address designating the memory 104b, and transmits the request from the host machine to the processor 103a.

The processor 103a stores, in the memory 104b, the request from the host machine, which is transmitted from the memory address translation unit 102a and designated with the address of the memory 104b as the storing destination, via the mutual address translation units 105a and 105b and the processor 103b according to the designated address.

The process of storing, in the memory 104b by the processor 103a, the request from the host machine designated with the address of the memory 104b as the storing destination via the mutual address translation units 105a and 105b and the processor 103b according to the designated address can be performed by providing a hardware mechanism in the processor 103a to automatically transmit the request to the mutual address translation unit 105a according to the designated address even when the processor 103a stops the operating of the request from the host machine although the processor 103a stops the operating of the request from the host machine in the second processing mode.

Next, the processor 103b reads out, from the memory 104b, the request from the host machine transmitted from the protocol chip 101a and starts the processing (502). If the request from the host machine read out from the memory 104b is a Write request, the processor 103b prepares to receive the Write data and transmits a transfer acknowledge of the Write data to the protocol chip 101a via the mutual address translation units 105b and 105a, the processor 103a, and the memory address translation unit 102a (503).

The protocol chip 101a that has received the Write data transfer acknowledge transmits the Write data transfer acknowledge to the host machine, and receives the Write data from the host machine. The protocol chip 101a stores the Write data received from the host machine in the memory 104b via the memory address translation unit 102a, the processor 103a, the mutual address translation units 105a and 105b, and the processor 103b (504).

Further, when receiving a signal indicating Write data transfer completion from the host machine, the protocol chip 101a stores the Write data transfer completion in the memory 104b similarly via the memory address translation unit 102a, the processor 103a, the mutual address translation units 105a and 105b, and the processor 103b (505). The process of storing the Write data and the Write data transfer completion into the memory 104b via the processor 103b may be performed by causing the processor 103b to execute some kind of instruction code, or may be performed by providing a hardware mechanism for automatically storing the data in the memory 104b in the processor 103b.

Next, the processor 103b reads out and checks the Write data transfer completion stored in the memory 104b (506). Thereafter, in the second processing mode, the Write data is not duplicated in the memory 104a and the memory 104b as in the first processing mode in consideration of the possibility that the memory 104a cannot be accessed due to a fault or the like. Instead, the Write data is directly stored in any one of the storage devices 107a to 107h, and a Write response is returned to the host machine.

That is, next, the processor 103b determines the storage devices 107a to 107h in which the Write data stored in the memory 104b is stored. In FIG. 5, it is assumed that the processor 103b determines to store the Write data stored in the memory 104b in the storage device 107a. Therefore, the processor 103b generates a data store request and transmits the data store request to the storage device 107a via the backend switch 106b (507).

The storage device 107a that has received the data store request transmits a data read request of the Write data to the processor 103b via the backend switch 106b (508). When receiving the data read request, the processor 103b reads out the Write data from the memory 104b (509), transmits the Write data to the storage device 107a via the backend switch 106b to store the Write data (510).

The reading-out of the Write data from the memory 104b by the processor 103b according to the data read out request of the Write data from the storage device 107a may be performed by causing the processor 103b to execute some kind of instruction code, or may be performed by providing a hardware mechanism for automatically reading out the Write data from the memory 104b in response to the read out request of the Write data in the processor 103b.

When receiving Write data, the storage device 107a stores the received Write data in an internal storage element or storage media. When storing the Write data into the internal storage element or storage media is completed, the storage device 107a generates a data store completion response and stores the data store completion response in the memory 104b via the backend switch 106b and the processor 103b (511).

The process of storing the data store completion response into the memory 104b via the processor 103b may be performed by causing the processor 103b to execute some kind of instruction code, or may be performed by providing a hardware mechanism for automatically storing the Write data in the memory 104b in the processor 103b.

Thereafter, the processor 103b reads out a data store completion response from the memory 104b and checks it (512). The processor 103b that has checked the data store completion response generates a Write response and stores the Write response in the memory 104b (513). Thereafter, the processor 103b generates a response notification notifying the protocol chip 101a that the Write response has been stored in the memory 104b, and transmits the response notification to the protocol chip 101a via the mutual address translation units 105b and 105a, the processor 103a, and the memory address translation unit 102a (514).

When receiving the response notification from the processor 103b, the protocol chip 101a designates an address indicating the memory 104a as a source of read out, and transmits a read out request of the Write response to the memory address translation unit 102a. In the second processing mode, by setting the address translation function of the memory address translation unit 102a to be effective, the memory address translation unit 102a translates the address designating the memory 104a as the read-out source into the address designating the memory 104b for the read out request of the Write response transmitted by the protocol chip 101a, and transmits the address to the processor 103a.

The processor 103a transmits, to the processor 103b, the read out request of the Write response, which is transmitted from the memory address translation unit 102a and designated with the address of the memory 104b as the read-out source, via the mutual address translation units 105a and 105b according to the designated address (515).

When receiving the Write response read out request from the protocol chip 101a, the processor 103b reads out the Write response from the memory 104b (516) and transmits the Read response to the protocol chip 101a via the mutual address translation units 105b and 105a, the processor 103a, and the memory address translation unit 102a (517).

The Write response read out from the memory 104b by the processor 103b according to the Write response read out request from the protocol chip 101a may be performed by causing the processor 103b to execute some kind of instruction code, or may be performed by providing a hardware mechanism that automatically reads out from the memory 104b in the processor 103b. When receiving the Write response from the processor 103b, the protocol chip 101a notifies the host machine that the Write processing has been completed.

The above is the operation in the storage system 1 when there is a Read request or a Write request from the host machine in the second processing mode in which the request from the host machine and the response of the result of processing the request from the host machine are stored in the memory 104b. By applying the second processing mode, it is possible to continue the processing of the request from the host machine even when the memory 104a cannot be accessed due to a fault or stopping power supply, or the processor 103a stops operating and cannot store or read out into or from the memory 104a.

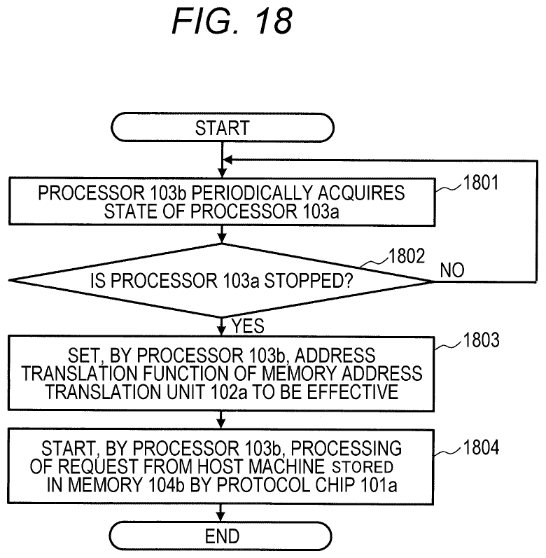

Next, an example of processing for switching from the first processing mode to the second processing mode in the first embodiment will be described with reference to FIG. 18.

FIG. 18 is an example of a process of switching from a first processing mode in which a Read request and a Write request from a host machine received by a protocol chip are stored in a memory included in the same controller as the one which includes the protocol chip and a response of the result of processing the request from the host machine is read out from a memory included in the same controller as the one which includes the protocol chip to a second processing mode in which the Read request and the Write request from the host machine received by the protocol chip are stored in a memory included in a controller different from the one which includes the protocol chip and the response of the result of processing the request from the host machine is read out from a memory included in a controller different from the one which includes the protocol chip in the first embodiment.

Hereinafter, in FIG. 18, it is assumed that the storage system 1 is in the first processing mode as an initial state, the request from the host machine received by the protocol chip 101a is stored in the memory 104a included in the same controller 110a as the one which includes the protocol chip 101a, and the response of the result of processing the request from the host machine is read out from the memory 104a. Therefore, it is assumed that an address indicating the memory 104a is set in the protocol chip 101a as a storing destination of a request from the host machine and a read-out source of a response of the result of processing the request from the host machine.

In FIG. 18, when the storage system 1 is in the first processing mode, the processor 103b included in the controller 110b different from the one which includes the protocol chip 101a periodically acquires the state of the processor 103a included in the same controller 110a as the one which includes the protocol chip 101a (step 1801).

Then, in step 1802, the processor 103b determines whether the processor 103a is stopped. The stop of the processor 103a includes a case where the processor 103a is stopped due to inaccessibility of the memory 104a connected to the processor 103a caused by a fault or the like. As a result of the determination, when the processor 103a is operating normally and is not stopped, the process returns to step 1801, and the processor 103b periodically acquires the state of the processor 103a again and repeats the determination in step 1802.

As a result of the determination, if the processor 103a is stopped, the process proceeds to step 1803, and the processor 103b sets the address translation function of the memory address translation unit 102a to be effective. By setting the address translation function of the memory address translation unit 102a to be effective, the address indicating the memory 104a to be designated as the storing destination of the request from the host machine and the read-out source of the result of processing the request from the host machine by the protocol chip 101a is translated by the memory address translation unit 102a so as to indicate the memory 104b of the controller 110b different from the one which includes the protocol chip 101a.

As a result, the storage system 1 switches the mode from the first processing mode in which the storing destination of the request from the host machine received by the protocol chip 101a and the source of read out of the response of the result of processing the request from the host machine are the memory 104a of the same controller 110a as the one which includes the protocol chip 101a to the second processing mode in which the destinations are the memory 104b of the controller 110b different from the one which includes the protocol chip 101a.

The effective setting signal of the address translation function of the memory address translation unit 102a may be transmitted from the processor 103b to the memory address translation unit 102a via the mutual address translation units 105b and 105a and the processor 103a illustrated in FIG. 1, or a dedicated signal line for this purpose may be provided between the processor 103b and the memory address translation unit 102a.

Next, in step 1804, the processor 103b starts processing the request from the host machine which is stored in the memory 104b by the protocol chip 101a, and stores a response of the result of processing the request from the host machine in the memory 104b.

As described above, it is possible to switch from the first processing mode in which a Read request and a Write request from a host machine received by a protocol chip are stored in a memory included in the same controller as the one which includes the protocol chip and a response of the result of processing the request from the host machine is read out from a memory included in the same controller as the one which includes the protocol chip to the second processing mode in which the Read request and the Write request from the host machine received by the protocol chip are stored in a memory included in a controller different from the one which includes the protocol chip and the response of the result of processing the request from the host machine is read out from a memory included in a controller different from the one which includes the protocol chip in the first embodiment.

As a result, even if a memory included in the same controller as the one which includes the protocol chip cannot be accessed due to a fault or the like, or a processor included in the same controller as the one which includes the protocol chip stops operating, a request from the host machine can be stored in a memory included in a controller different from the one which includes the protocol chip, and a response of the result of processing the request from the host machine can be read out from a memory included in a controller different from the one which includes the protocol chip, so that processing of the request from the host machine can be continued.

### Second Embodiment

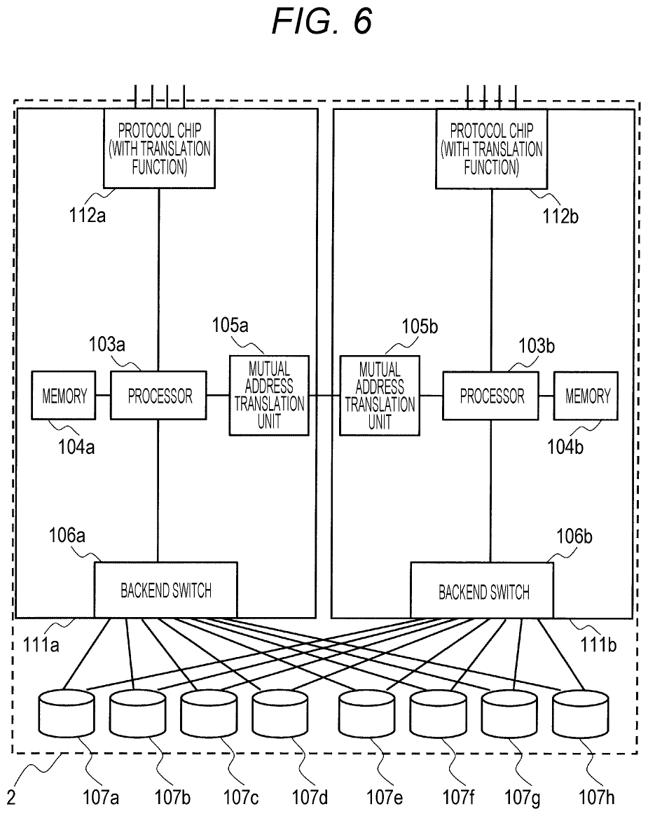

Next, a second embodiment will be described with reference to FIGS. 6, 7, 8, 9, 10, and 16.

FIG. 6 is an example of a structure of a storage system according to the second embodiment.

In FIG. 6, as compared with the example of the structure of the storage system illustrated in FIG. 1, the memory address translation units 102a and 102b are removed. Instead, protocol chips 112a and 112b have a translation function, that is, a memory address translation unit is included in each of the protocol chips 112a and 112b.

That is, a controller 111a includes one protocol chip (with translation function) 112a, a processor 103a, a memory 104a, a mutual address translation unit 105a, and a backend switch 106a.

A controller 1l1b includes one protocol chip (with translation function) 112b, a processor 103b, a memory 104b, a mutual address translation unit 105b, and a backend switch 106b.

The protocol chips (with translation function) 112a and 112b are connected to a host machine (not illustrated), and control a protocol of data transmission performed by the host machine with a storage system 2. Further, the protocol chips (with translation function) 112a and 112b have a function of translating (switching) the designation of an address indicating the memory 104a and an address indicating the memory 104b for storing a request from the host machine and reading out a response of the result of processing of the request from the host machine according to the setting from the processor 103a or 103b. Note that, in FIG. 6, the protocol chips (with translation function) 112a and 112b are provided in the controllers 111a and 1l1b, respectively, but the number of protocol chips (with translation function) in the controller is not limited to one and can be any number.

The processors 103a and 103b, the memories 104a and 104b, the mutual address translation units 105a and 105b, the backend switches 106a and 106b, and the storage devices 107a to 107h are the same as those corresponding to the first embodiment illustrated in FIG. 1.

In the first processing mode, the storage system 2 of the present embodiment stores a Read request and a Write request from the host machine received by the protocol chip (with translation function) 112a in the memory 104a included in the same controller 111a as the one which includes the protocol chip (with translation function) 112a, and reads out, from the memory 104a, a response of the result of processing the request from the host machine.

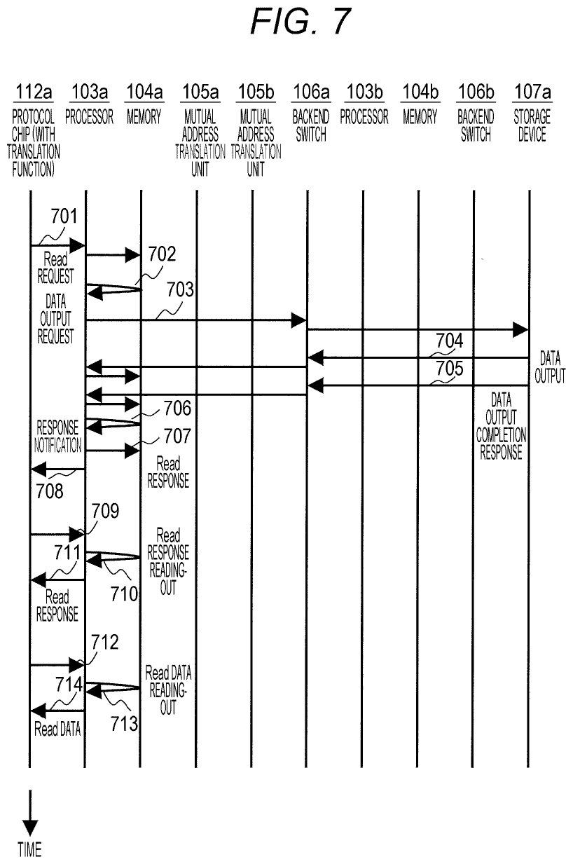

In addition, in the second processing mode, the storage system 2 of the present embodiment stores a Read request and a Write request from the host machine received by the protocol chip (with translation function) 112a in the memory 104b included in the controller 1l1b different from the one which includes the protocol chip (with translation function) 112a, and reads out, from the memory 104b, a response of the result of processing the request from the host machine. A state of this operation will be described with reference to FIGS. 7, 8, 9, and 10.

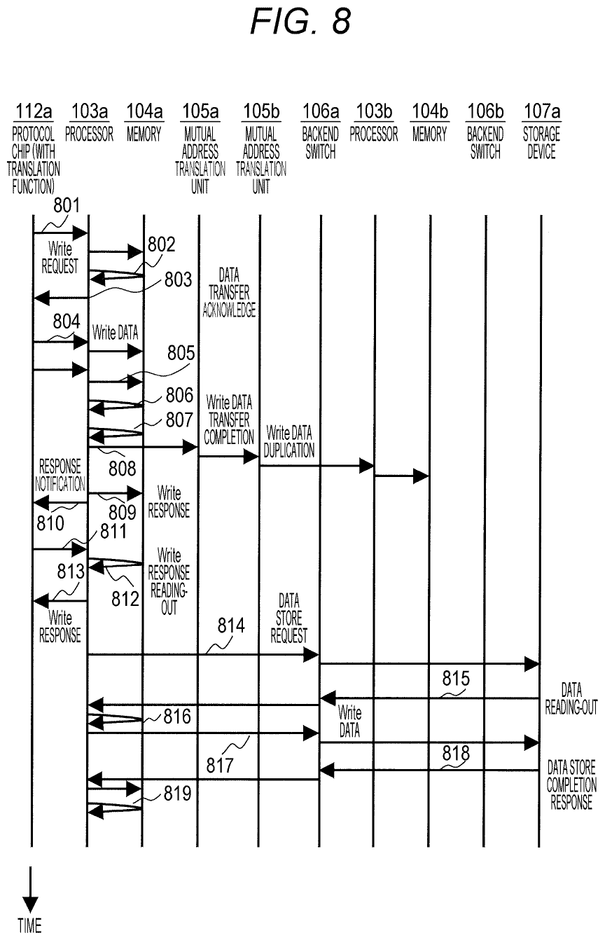

FIG. 7 is an example of a processing sequence in a case where the storage system 2 receives a Read request from the host machine in the first processing mode. In FIG. 7, each vertical line indicates a time order of a request or a response transmitted or received by a part described above. It is assumed that the time progresses from the top to the bottom in the drawing (the same applies to FIGS. 8, 9, and 10 below).

In FIG. 7, when receiving a Read request from a host machine (not illustrated), the protocol chip (with translation function) 112a designates an address indicating the memory 104a as a storing destination and transmits the request from the host machine to the processor 103a (701). In the first processing mode, the protocol chip (with translation function) 112a designates an address indicating the memory 104a as a storing destination of a request from the host machine.

The processor 103a stores, in the memory 104a, the request from the host machine, which is transmitted from the protocol chip (with translation function) 112a and designated with the address of the memory 104a as the storing destination, according to the designated address. The process of storing into the memory 104a by the processor 103a may be performed by causing the processor 103a to execute some kind of instruction code, or may be performed by providing a hardware mechanism for automatically storing in the memory 104a according to a designated address in the processor 103a.

Next, the processor 103a reads out the request, which is from the host machine transmitted from the protocol chip (with translation function) 112a, from the memory 104a and starts the processing (702). If the request from the host machine read out from the memory 104a is a Read request, the processor 103a determines in which of the storage devices 107a to 107h the requested data is held, generates a data output request to the storage device, that is, the storage device 107a in the example of FIG. 7, and transmits the data output request via the backend switch 106a (703).

The storage device 107a acquires the requested data from an internal storage element or a storage media, and stores the data in the memory 104a via the backend switch 106a and the processor 103a (704). Furthermore, the storage device 107a generates a data output completion response indicating that the requested data has been successfully stored in the memory 104a, and stores the data output completion response in the memory 104a similarly via the backend switch 106a and the processor 103a (705).

The process of storing the data from the storage device 107a and the data output completion response via the processor 103a into the memory 104a may be performed by causing the processor 103a to execute some kind of instruction code, or may be performed by providing a hardware mechanism that automatically stores the data in the memory 104a in the processor 103a.

Next, the processor 103a reads out the data output completion response written from the storage device 107a to the memory 104a from the memory 104a (706). In accordance with the read-out data output completion response, the processor 103a generates a Read response to be transmitted to the host machine, and stores the Read response in the memory 104a (707). Thereafter, the processor 103a transmits a response notification notifying the protocol chip (with translation function) 112a that the Read response has been stored in the memory 104a (708).

When receiving the response notification from the processor 103a, the protocol chip (with translation function) 112a designates the address of the memory 104a and transmits a read out request for the Read response to the processor 103a (709).

In the first processing mode, the protocol chip (with translation function) 112a designates an address indicating the memory 104a as a source of read out of the Read response. When receiving the Read response read out request from the protocol chip (with translation function) 112a, the processor 103a reads out the Read response from the memory 104a (710) and transmits the Read response to the protocol chip (with translation function) 112a (711).

The Read response read out from the memory 104a by the processor 103a according to the Read response read out request from the protocol chip (with translation function) 112a may be performed by causing the processor 103a to execute some kind of instruction code, or may be performed by providing a hardware mechanism that automatically reads out from the memory 104a in the processor 103a.

When receiving the Read response from the processor 103a, the protocol chip (with translation function) 112a transmits a Read data read out request for extracting Read data from the memory 104a to the processor 103a (712). In accordance with the transmitted Read data read out request, the processor 103a reads out the Read data (713), and transmits the read-out Read data to the protocol chip (with translation function) 112a (714).

The Read data read out from the memory 104a by the processor 103a according to the Read data read out request from the protocol chip (with translation function) 112a may be performed by causing the processor 103a to execute some kind of instruction code, or may be performed by providing a hardware mechanism that automatically reads out data from the memory 104a in the processor 103a. When receiving the Read data from the processor 103a, the protocol chip (with translation function) 112a transmits the Read data to a host machine (not illustrated).

FIG. 8 is an example of a processing sequence in a case where the storage system 2 receives a Write request from the host machine in the first processing mode.

In FIG. 8, when receiving a Write request from a host machine (not illustrated), the protocol chip (with translation function) 112a designates an address indicating the memory 104a as a storing destination and transmits the request from the host machine to the processor 103a (801). In the first processing mode, the protocol chip (with translation function) 112a designates an address indicating the memory 104a as a storing destination of a request from the host machine.

The processor 103a stores, in the memory 104a, the request from the host machine, which is transmitted from the protocol chip (with translation function) 112a and designated with the address of the memory 104a as the storing destination, according to the designated address. The process of storing into the memory 104a by the processor 103a may be performed by causing the processor 103a to execute some kind of instruction code, or may be performed by providing a hardware mechanism for automatically storing in the memory 104a according to a designated address in the processor 103a.

Next, the processor 103a reads out the request, which is from the host machine transmitted from the protocol chip (with translation function) 112a, from the memory 104a and starts the processing (802). If the request from the host machine read out from the memory 104a is a Write request, the processor 103a prepares to receive the Write data and transmits a transfer acknowledge of the Write data to the protocol chip (with translation function) 112a (803).

The protocol chip (with translation function) 112a that has received the Write data transfer acknowledge transmits the Write data transfer acknowledge to the host machine, and receives the Write data from the host machine. The protocol chip (with translation function) 112a stores the Write data received from the host machine in the memory 104a via the processor 103a (804).

Further, when receiving a signal indicating Write data transfer completion from the host machine, the protocol chip (with translation function) 112a stores the Write data transfer completion in the memory 104a similarly via the processor 103a (805). The process of storing the Write data and the Write data transfer completion into the memory 104a via the processor 103a may be performed by causing the processor 103a to execute some kind of instruction code, or may be performed by providing a hardware mechanism for automatically storing the data in the memory 104a in the processor 103a.

Next, the processor 103a reads out and checks the Write data transfer completion stored in the memory 104a (806). Thereafter, the processor 103a reads out the Write data from the memory 104a (807), and transmits the Write data to be stored in the memory 104b via the mutual address translation units 105a and 105b and the processor 103b (808).

This is because the Write data is to be duplicated in the memory 104a and the memory 104b, and even if the one of memory 104a or 104b becomes inaccessible due to a fault or stopping power supply, or the processor 103a or 103b stops operating, the Write data received from the host machine is not lost.

In addition, the process of storing the Write data in the memory 104b via the processor 103b may be performed by causing the processor 103b to execute some kind of instruction code, or may be performed by providing a hardware mechanism for automatically storing the Write data in the memory 104b in the processor 103b.

When the process of duplicating the Write data is completed, the processor 103a generates a Write response and stores the Write response in the memory 104a (809). Thereafter, the processor 103a transmits a response notification notifying the protocol chip (with translation function) 112a that the Write response has been stored in the memory 104a (810).

When receiving the response notification from the processor 103a, the protocol chip (with translation function) 112a designates the address of the memory 104a and transmits a read out request for the Write response to the processor 103a (811). In the first processing mode, the protocol chip (with translation function) 112a designates an address indicating the memory 104a as a source of read out of the Write response.

When receiving the Write response read out request from the protocol chip 101a, the processor 103a reads out the Write response from the memory 104a (812) and transmits the Write response to the protocol chip (with translation function) 112a (813). The Write response read out from the memory 104a by the processor 103a according to the Write response read out request from the protocol chip (with translation function) 112a may be performed by causing the processor 103a to execute some kind of instruction code, or may be performed by providing a hardware mechanism that automatically reads out from the memory 104a in the processor 103a.

When receiving the Write response from the processor 103a, the protocol chip (with translation function) 112a notifies the host machine that the Write processing has been completed.

Next, the processor 103a determines the storage devices 107a to 107h in which the Write data stored in the memory 104a is stored. In FIG. 8, it is assumed that the processor 103a determines to store the Write data stored in the memory 104a in the storage device 107a. Therefore, the processor 103a generates a data store request and transmits the data store request to the storage device 107a via the backend switch 106a (814).

The storage device 107a that has received the data store request transmits a data read request of the Write data to the processor 103a via the backend switch 106a (815). When receiving the data read request, the processor 103a reads out the Write data from the memory 104a (816), transmits the Write data to the storage device 107a via the backend switch 106a to store the Write data (817).

The reading-out of the Write data from the memory 104a by the processor 103a according to the data read out request of the Write data from the storage device 107a may be performed by causing the processor 103a to execute some kind of instruction code, or may be performed by providing a hardware mechanism for automatically reading out the Write data from the memory 104a in response to the read out request of the Write data in the processor 103a.

When receiving Write data, the storage device 107a stores the received Write data in an internal storage element or storage media. When the storing of the Write data into the internal storage element or storage media is completed, the storage device 107a generates a data store completion response and stores the data store completion response in the memory 104a via the backend switch 106a and the processor 103a (818).

The process of storing the data store completion response into the memory 104a via the processor 103a may be performed by causing the processor 103a to execute some kind of instruction code, or may be performed by providing a hardware mechanism for automatically storing the data in the memory 104a in the processor 103a. Finally, the processor 103a reads out the data store completion response from the memory 104a and checks it (819).

The above is the operation in the storage system 2 when there is a Read request or a Write request from the host machine in the first processing mode in which the request from the host machine and the response of the result of processing the request from the host machine are stored in the memory 104a.

In a case where the memory 104a cannot be accessed due to a fault or stopping power supply, or the processor 103a stops operating and cannot store or read out into or from the memory 104a, a second processing mode of storing a request from the host machine and a response of the result of processing the request from the host machine in the memory 104b is applied instead of the memory 104a. By applying the second processing mode, it is possible to continue the processing of the request from the host machine even when the memory 104a cannot be accessed due to a fault or stopping power supply, or the processor 103a stops operating and cannot store or read out into or from the memory 104a.

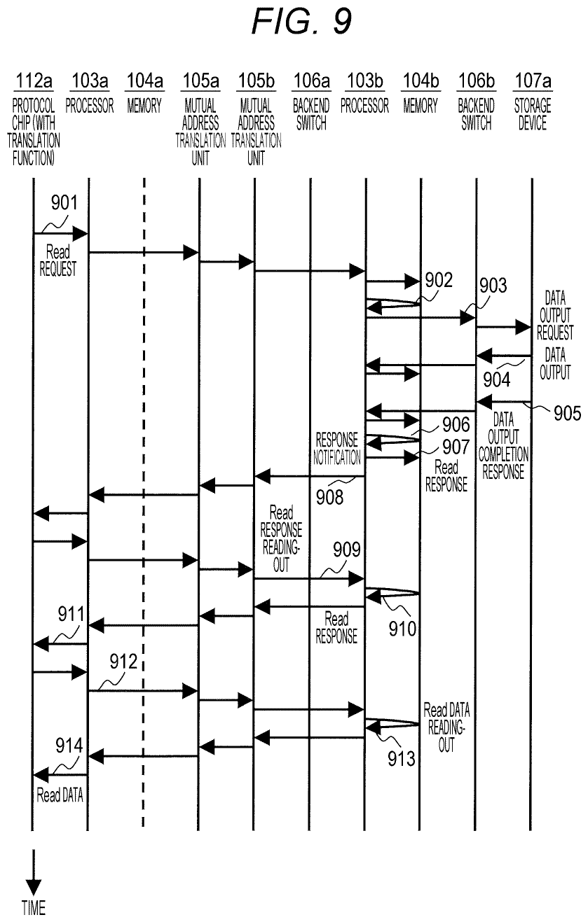

FIG. 9 is an example of a processing sequence in the storage system 2 when a Read request is received from the host machine in a case where the second processing mode is applied.

In FIG. 9, when receiving a Read request from a host machine (not illustrated), the protocol chip (with translation function) 112a designates an address indicating the memory 104b as a storing destination and transmits the request from the host machine to the processor 103a (901). In the second processing mode, the protocol chip (with translation function) 112a designates an address indicating the memory 104b as a storing destination of a request from the host machine.

The processor 103a stores, in the memory 104b, the request from the host machine, which is transmitted from the protocol chip (with translation function) 112a and designated with the address of the memory 104b as the storing destination, via the mutual address translation units 105a and 105b and the processor 103b according to the designated address.

The process of storing, in the memory 104b by the processor 103a, the request from the host machine designated with the address of the memory 104b as the storing destination via the mutual address translation units 105a and 105b and the processor 103b according to the designated address can be performed by providing a hardware mechanism in the processor 103a to automatically transmit the request to the mutual address translation unit 105a according to the designated address even when the processor 103a stops the operating of the request from the host machine although the processor 103a stops the operating of the request from the host machine in the second processing mode.

Next, the processor 103b reads out the request, which is from the host machine transmitted from the protocol chip (with translation function) 112a, from the memory 104b and starts the processing (902). If the request from the host machine read out from the memory 104b is a Read request, the processor 103b determines in which of the storage devices 107a to 107h the requested data is held, generates a data output request to the storage device, that is, the storage device 107a in the example of FIG. 9, and transmits the data output request via the backend switch 106b (903).

The storage device 107a acquires the requested data from an internal storage element or a storage media, and stores the data in the memory 104b via the backend switch 106b and the processor 103b (904). Furthermore, the storage device 107a generates a data output completion response indicating that the requested data has been successfully stored in the memory 104b, and stores the data output completion response in the memory 104b similarly via the backend switch 106b and the processor 103b (905).

The process of storing the data from the storage device 107a and the data output completion response via the processor 103b into the memory 104b may be performed by causing the processor 103b to execute some kind of instruction code, or may be performed by providing a hardware mechanism that automatically stores the data in the memory 104b in the processor 103b.

Next, the processor 103b reads out the data output completion response written from the storage device 107a to the memory 104b from the memory 104b (906). In accordance with the read-out data output completion response, the processor 103b generates a Read response to be transmitted to the host machine, and stores the Read response in the memory 104b (907). Thereafter, the processor 103b generates a response notification notifying the protocol chip (with translation function) 112a that the Read response has been stored in the memory 104b, and transmits the response notification to the protocol chip (with translation function) 112a via the mutual address translation units 105b and 105a, and the processor 103a (908).

When receiving the response notification from the processor 103a, the protocol chip (with translation function) 112a designates the address indicating the memory 104b as the read-out source and transmits a read out request for the Read response to the processor 103b. In the second processing mode, the protocol chip (with translation function) 112a designates an address indicating the memory 104b as a source of read out of the Read response.

The processor 103a transmits, to the processor 103b, the read out request of the Read response, which is transmitted from the memory address translation unit 102a and designated with the address of the memory 104b as the read-out source, via the mutual address translation units 105a and 105b according to the designated address (909).

When receiving the Read response read out request from the protocol chip (with translation function) 112a, the processor 103b reads out the Read response from the memory 104b (910) and transmits the Read response to the protocol chip (with translation function) 112a via the mutual address translation units 105b and 105a, and the processor 103a (911).

The Read response read out from the memory 104b by the processor 103b according to the Read response read out request from the protocol chip (with translation function) 112a may be performed by causing the processor 103b to execute some kind of instruction code, or may be performed by providing a hardware mechanism that automatically reads out from the memory 104b in the processor 103b.

When receiving the Read response from the processor 103b, the protocol chip (with translation function) 112a transmits a Read data read out request for extracting Read data from the memory 104b to the processor 103b via the processor 103a, the mutual address translation units 105a and 105b according to the response content (912).

In accordance with the transmitted Read data read out request, the processor 103b reads out the Read data (913), and transmits the read-out Read data to the protocol chip (with translation function) 112a via the mutual address translation units 105b and 105a, and the processor 103a (914).

The Read data read out from the memory 104b by the processor 103b according to the Read data read out request from the protocol chip (with translation function) 112a may be performed by causing the processor 103b to execute some kind of instruction code, or may be performed by providing a hardware mechanism that automatically reads out data from the memory 104b in the processor 103b. When receiving the Read data from the processor 103b, the protocol chip (with translation function) 112a transmits the Read data to a host machine (not illustrated).

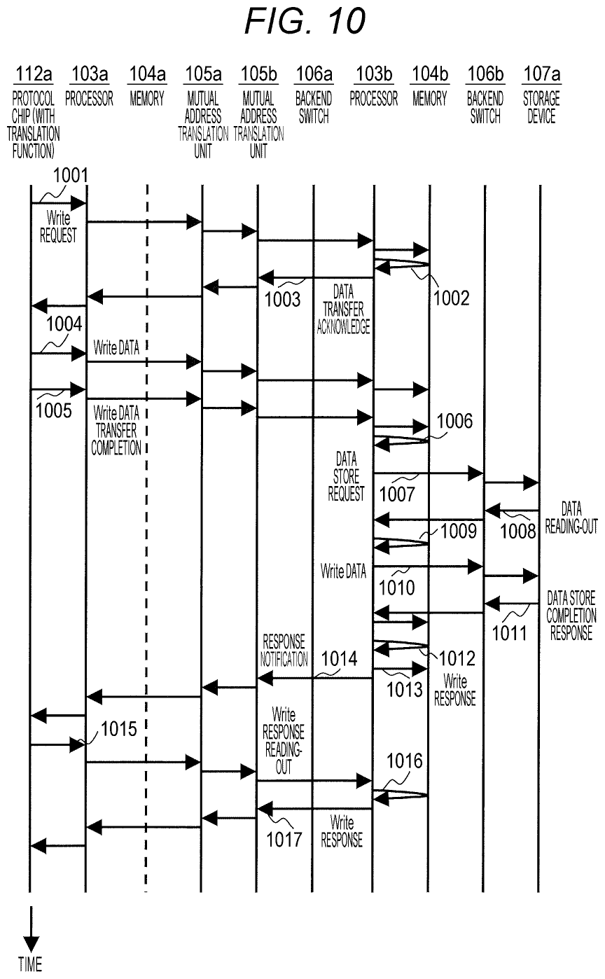

FIG. 10 is an example of a processing sequence in a case where the storage system 2 receives a Write request from the host machine in the second processing mode.

In FIG. 10, when receiving a Write request from a host machine (not illustrated), the protocol chip (with translation function) 112a designates an address indicating the memory 104b as a storing destination and transmits the request from the host machine to the processor 103a (1001). In the second processing mode, the protocol chip (with translation function) 112a designates an address indicating the memory 104b as a storing destination of a request from the host machine.

The processor 103a stores, in the memory 104b, the request from the host machine, which is transmitted from the protocol chip (with translation function) 112a and designated with the address of the memory 104b as the storing destination, via the mutual address translation units 105a and 105b and the processor 103b according to the designated address.

The process of storing, in the memory 104b by the processor 103a, the request from the host machine designated with the address of the memory 104b as the storing destination via the mutual address translation units 105a and 105b and the processor 103b according to the designated address can be performed by providing a hardware mechanism in the processor 103a to automatically transmit the request to the mutual address translation unit 105a according to the designated address even when the processor 103a stops the operating of the request from the host machine although the processor 103a stops the operating of the request from the host machine in the second processing mode.

Next, the processor 103b reads out the request, which is from the host machine transmitted from the protocol chip (with translation function) 112a, from the memory 104b and starts the processing (1002). If the request from the host machine read out from the memory 104b is a Write request, the processor 103b prepares to receive the Write data and transmits a transfer acknowledge of the Write data to the protocol chip (with translation function) 112a via the mutual address translation units 105b and 105a, and the processor 103a (1003).

The protocol chip (with translation function) 112a that has received the Write data transfer acknowledge transmits the Write data transfer acknowledge to the host machine, and receives the Write data from the host machine. The protocol chip (with translation function) 112a stores the Write data received from the host machine in the memory 104b via the processor 103a, the mutual address translation units 105a and 105b, and the processor 103b (1004).

Further, when receiving a signal indicating Write data transfer completion from the host machine, the protocol chip (with translation function) 112a stores the Write data transfer completion in the memory 104b similarly via the processor 103a, the mutual address translation units 105a and 105b, and the processor 103b (1005).

The process of storing the Write data and the Write data transfer completion into the memory 104b via the processor 103b may be performed by causing the processor 103b to execute some kind of instruction code, or may be performed by providing a hardware mechanism for automatically storing the data in the memory 104b in the processor 103b.

Next, the processor 103b reads out and checks the Write data transfer completion stored in the memory 104b (1006). Thereafter, in the second processing mode, the Write data is not duplicated in the memory 104a and the memory 104b as in the first processing mode in consideration of the possibility that the memory 104a cannot be accessed due to a fault or the like.

Instead, the Write data is directly stored in any one of the storage devices 107a to 107h, and a Write response is returned to the host machine. That is, next, the processor 103b determines the storage devices 107a to 107h in which the Write data stored in the memory 104b is stored. In FIG. 10, it is assumed that the processor 103b determines to store the Write data stored in the memory 104b in the storage device 107a.

Therefore, the processor 103b generates a data store request and transmits the data store request to the storage device 107a via the backend switch 106b (1007). The storage device 107a that has received the data store request transmits a data read request of the Write data to the processor 103b via the backend switch 106b (1008).

When receiving the data read request, the processor 103b reads out the Write data from the memory 104b (1009), transmits the Write data to the storage device 107a via the backend switch 106b to store the Write data (1010).

The reading-out of the Write data from the memory 104b by the processor 103b according to the data read out request of the Write data from the storage device 107a may be performed by causing the processor 103b to execute some kind of instruction code, or may be performed by providing a hardware mechanism for automatically reading out the Write data from the memory 104b in response to the read out request of the Write data in the processor 103b.

When receiving Write data, the storage device 107a stores the received Write data in an internal storage element or storage media. When the storing of the Write data into the internal storage element or storage media is completed, the storage device 107a generates a data store completion response and stores the data store completion response in the memory 104b via the backend switch 106b and the processor 103b (1011).

The process of storing the data store completion response into the memory 104b via the processor 103b may be performed by causing the processor 103b to execute some kind of instruction code, or may be performed by providing a hardware mechanism for automatically storing the Write data in the memory 104b in the processor 103b.

Thereafter, the processor 103b reads out a data store completion response from the memory 104b and checks it (1012). The processor 103b that has checked the data store completion response generates a Write response and stores the Write response in the memory 104b (1013). Thereafter, the processor 103b generates a response notification notifying the protocol chip (with translation function) 112a that the Write response has been stored in the memory 104b, and transmits the response notification to the protocol chip (with translation function) 112a via the mutual address translation units 105b and 105a, and the processor 103a (1014).

When receiving the response notification from the processor 103a, the protocol chip (with translation function) 112a designates the address indicating the memory 104b as the read-out source and transmits a read out request for the Write response to the processor 103b. In the second processing mode, the protocol chip (with translation function) 112a designates an address indicating the memory 104b as a source of read out of the Write response.

The processor 103a transmits, to the processor 103b, the read out request of the Write response, which is transmitted from the protocol chip (with translation function) 112a and designated with the address of the memory 104b as the read-out source, via the mutual address translation units 105a and 105b according to the designated address (1015).

When receiving the Write response read out request from the protocol chip (with translation function) 112a, the processor 103b reads out the Write response from the memory 104b (1016) and transmits the Write response to the protocol chip (with translation function) 112a via the mutual address translation units 105b and 105a, and the processor 103a (1017).

The Write response read out from the memory 104b by the processor 103b according to the Write response read out request from the protocol chip (with translation function) 112a may be performed by causing the processor 103b to execute some kind of instruction code, or may be performed by providing a hardware mechanism that automatically reads out from the memory 104b in the processor 103b.

When receiving the Write response from the processor 103b, the protocol chip (with translation function) 112a notifies the host machine that the Write processing has been completed.

The above is the operation in the storage system 2 when there is a Read request or a Write request from the host machine in the second processing mode in which the request from the host machine and the response of the result of processing the request from the host machine are stored in the memory 104b. By applying the second processing mode, it is possible to continue the processing of the request from the host machine even when the memory 104a cannot be accessed due to a fault or stopping power supply, or the processor 103a stops operating and cannot store or read out into or from the memory 104a.

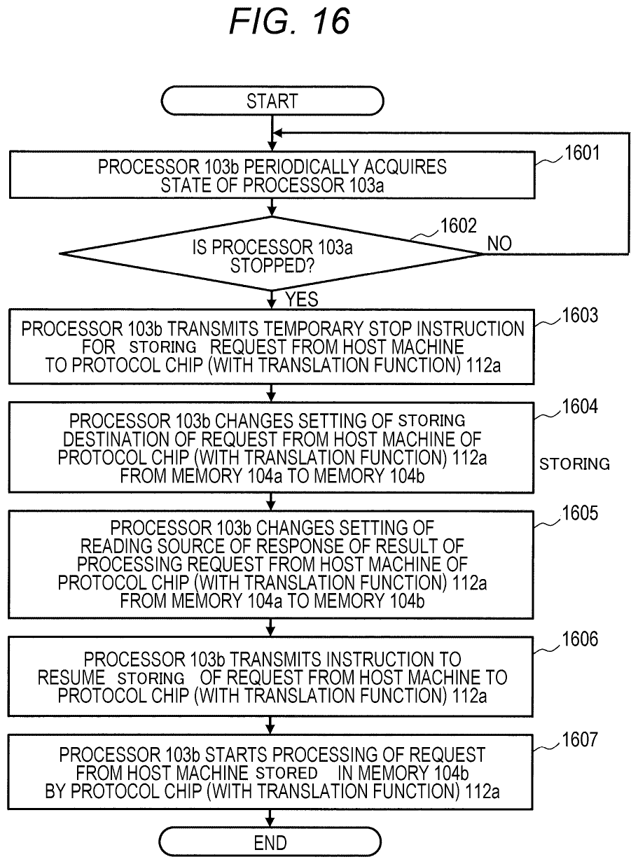

Next, an example of processing for switching from the first processing mode to the second processing mode in the second embodiment will be described with reference to FIG. 16.

FIG. 16 is an example of a process of switching from a first processing mode in which a Read request and a Write request from a host machine received by a protocol chip are stored in a memory included in the same controller as the one which includes the protocol chip and a response of the result of processing the request from the host machine is read out from a memory included in the same controller as the one which includes the protocol chip to a second processing mode in which the Read request and the Write request from the host machine received by the protocol chip are stored in a memory included in a controller different from the one which includes the protocol chip and the response of the result of processing the request from the host machine is read out from a memory included in a controller different from the one which includes the protocol chip in the second embodiment of the present invention.

In the second embodiment, the storing destination of the request from the host machine is set in the protocol chip (with translation function) 112, but at that time, if the storing destination of the request is changed while the protocol chip (with translation function) 112 is performing the operation of storing the request from the host machine, there may be a case where a malfunction occurs. Alternatively, in order to avoid such a malfunction, it is also conceivable that the protocol chip (with translation function) 112 has a specification that does not accept a change in the storing destination of the request from the host machine while performing the operation of storing the request from the host machine.

In such a case, prior to setting the storing destination of the request from the host machine, it is necessary to instruct the protocol chip (with translation function) 112 to stop the operating of storing the request from the host machine. In the present embodiment, such a case will be described.

Hereinafter, in FIG. 16, it is assumed that the storage system 2 is in the first processing mode as an initial state, the protocol chip (with translation function) 112a designates an address indicating the memory 104a included in the same controller 111a as the one which includes the protocol chip (with translation function) 112a and stores a request from the host machine, and similarly designates an address indicating the memory 104a and reads out a response of the result of processing the request from the host machine.

That is, when the storage system 2 is in the first processing mode, the processor 103b included in the controller 1l1b different from the one which includes the protocol chip (with translation function) 112a periodically acquires the state of the processor 103a included in the same controller 111a as the one which includes the protocol chip (with translation function) 112a (step 1601).

Then, in step 1602, the processor 103b determines whether the processor 103a is stopped. The stop of the processor 103a includes a case where the memory 104a connected to the processor 103a is stopped due to inaccessibility caused by a fault or the like. As a result of the determination, when the processor 103a is operating normally and is not stopped, the process returns to step 1601, and the processor 103b periodically acquires the state of the processor 103a again and repeats the determination in step 1602.

As a result of the determination, if the processor 103a is stopped, the process proceeds to step 1603, and the processor 103b transmits, to the protocol chip (with translation function) 112a, an instruction to temporarily stop storing the request from the host machine into the memory 104a, and temporarily stops storing the request from the host machine into the memory 104a.

The instruction to temporarily stop storing the request from the host machine into the memory 104a may be transmitted to the protocol chip (with translation function) 112a of the processor 103b via the mutual address translation units 105b and 105a and the processor 103a illustrated in FIG. 6, or a dedicated signal line for this purpose may be particularly provided between the processor 103b and the protocol chip (with translation function) 112a.

Next, in step 1604, the processor 103b changes the setting of the storing destination of the request from the host machine of the protocol chip (with translation function) 112a from the memory 104a included in the same controller 111a as the one which includes the protocol chip (with translation function) 112a to the memory 104b included in the controller 1l1b different from the one which includes the protocol chip (with translation function) 112a.

This setting change can be performed, for example, by providing a storing destination address register that designates an address of a storing destination of a request from the host machine in the protocol chip (with translation function) 112a and rewriting the content from the address indicating the memory 104a to the address indicating the memory 104b. Note that such rewriting of the storing destination address register may also be performed by the processor 103b via the mutual address translation units 105b and 105a and the processor 103a illustrated in FIG. 6, or a dedicated signal line for this purpose may be particularly provided between the processor 103b and the protocol chip (with translation function) 112a.

Next, in step 1605, the processor 103b changes the setting of the reading source of the response of the result of processing the request from the host machine of the protocol chip (with translation function) 112a from the memory 104a included in the same controller 111a as the one which includes the protocol chip (with translation function) 112a to the memory 104b included in the controller 1l1b different from the one which includes the protocol chip (with translation function) 112a.

This setting change can also be performed, for example, by providing a read-out source address register that specifies an address of a source of read out of a response of the result of processing a request from the host machine in the protocol chip (with translation function) 112a and rewriting the content from the address indicating the memory 104a to the address indicating the memory 104b. Note that such rewriting of the read-out source address register may also be performed by the processor 103b via the mutual address translation units 105b and 105a and the processor 103a illustrated in FIG. 6, or a dedicated signal line for this purpose may be particularly provided between the processor 103b and the protocol chip (with translation function) 112a.

As described above, by executing the processing of steps 1604 and 1605, the protocol chip (with translation function) 112a stores the request from the host machine in the memory 104b included in the controller 1l1b different from the one which includes the protocol chip (with translation function) 112a, and reads out the response of the result of processing the request from the host machine from the memory 104b included in the controller 1l1b different from the one which includes the protocol chip (with translation function) 112a. Therefore, the storage system 2 is switched from the first processing mode to the second processing mode.

Therefore, in step 1606, the processor 103b transmits an instruction to restart the storing of the request from the host machine to the protocol chip (with translation function) 112a, and restarts the storing of the request from the host machine. However, in this case, since the storing destination is changed from the memory 104a to the memory 104b in step 1604, the storing destination becomes the memory 104b.

In addition, the instruction to resume the storing of the request from the host machine may be transmitted to the protocol chip (with translation function) 112a of the processor 103b via the mutual address translation units 105b and 105a and the processor 103a illustrated in FIG. 6, or a dedicated signal line for this purpose may be particularly provided between the processor 103b and the protocol chip (with translation function) 112a.

Finally, in step 1607, the processor 103b starts processing for the request from the host machine stored in the memory 104b by the protocol chip (with translation function) 112a.

As described above, it is possible to switch from the first processing mode in which a Read request and a Write request from a host machine received by a protocol chip are stored in a memory included in the same controller as the one which includes the protocol chip and a response of the result of processing the request from the host machine is read out from a memory included in the same controller as the one which includes the protocol chip to the second processing mode in which the Read request and the Write request from the host machine received by the protocol chip are stored in a memory included in a controller different from the one which includes the protocol chip and the response of the result of processing the request from the host machine is read out from a memory included in a controller different from the one which includes the protocol chip in the first embodiment.

As a result, even if a memory included in the same controller as the one which includes the protocol chip cannot be accessed due to a fault or the like, or a processor included in the same controller as the one which includes the protocol chip stops operating, a request from the host machine can be stored in a memory included in a controller different from the one which includes the protocol chip, and a response of the result of processing the request from the host machine can be read out from a memory included in a controller different from the one which includes the protocol chip, so that processing of the request from the host machine can be continued.

Further, since the storing of the request from the host machine is temporarily stopped in the protocol chip and then the setting of the storing destination of the request from the host machine is changed in the protocol chip, it is possible to prevent the protocol chip from malfunctioning or not accepting the setting change of the storing destination of the request from the host machine.

### Third Embodiment

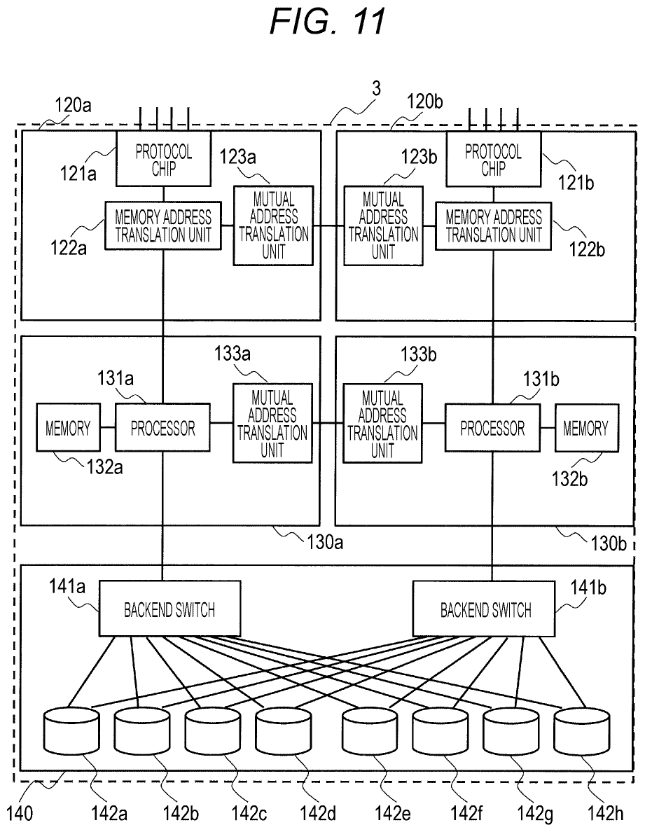

A third embodiment will be described with reference to FIGS. 11, 12, 13, 14, and 15.

FIG. 11 is an example of a structure of a storage system according to the third embodiment.

In FIG. 11, a storage system 3 includes two interface units 120a and 120b, two processor board units 130a and 130b, and one drive box 140. The processor board units 130a and 130b and the interface units 120a and 120b are exchangeable independently of each other.

The interface unit 120a includes one protocol chip 121a, a memory address translation unit 122a, and a mutual address translation unit 123a.

The interface unit 120b includes one protocol chip 121b, a memory address translation unit 122b, and a mutual address translation unit 123b.

In FIG. 11, two interface units of the interface units 120a and 120b are provided, but the number of interface units in the storage system is not limited to two, and can be any number of one or more.

The protocol chips 121a and 121b are connected to a host machine (not illustrated), and control a protocol of data transmission performed by the host machine with the storage system 3. In FIG. 11, the protocol chips 121a and 121b are provided in the interface units 120a and 120b, respectively, but the number of protocol chips in the interface unit is not limited to one and can be any number.

The processor board unit 130a includes a processor 131a, a memory 132a, and a mutual address translation unit 133a.

The processor board unit 130b includes a processor 131b, a memory 132b, and a mutual address translation unit 133b.

The memory address translation unit 122a has a function of translating an address of the memory 132a used by the protocol chip 121a to store a request from the host machine into an address indicating the memory 132b, and translating an address of the memory 132a used by the protocol chip 121a to read out a response of the result of processing the request from the host machine into an address indicating the memory 132b.

Further, when the address translation function of translating the address indicating the memory 132b is enabled, the memory address translation unit 122a in FIG. 11 transmits a request and a response to the mutual address translation unit 123a instead of the processor 131a, transmits the request and the response to the processor 131b via the mutual address translation units 123a and 123b and the memory address translation unit 122b, stores or reads out the request and the response in or from the memory 132b for storing the request from the host machine or reading out the response of the result of processing the request from the host machine.

Similarly, the memory address translation unit 122b has a function of translating an address of the memory 132b used by the protocol chip 121b to store a request from the host machine into an address indicating the memory 132a, and translating an address of the memory 132b used by the protocol chip 121b to read out a response of the result of processing the request from the host machine into an address indicating the memory 132a.

Further, when the address translation function of translating the address indicating the memory 132a is enabled, the memory address translation unit 122b in FIG. 11 transmits a request and a response to the mutual address translation unit 123b instead of the processor 131b, transmits the request and the response to the processor 131a via the mutual address translation units 123b and 123a and the memory address translation unit 122a, stores or reads out the request and the response in or from the memory 132a for storing the request from the host machine or reading out the response of the result of processing the request from the host machine.

In FIG. 11, the memory address translation units 122a and 122b are provided in the interface units 120a and 120b, respectively, but the number of memory address translation units in the interface unit is not limited to one and can be any number. Furthermore, in FIG. 11, the memory address translation units 122a and 122b are connected to the protocol chips 121a and 121b, respectively, but the number of memory address translation units may be smaller than the number of protocol chips. In a case where the number of memory address translation units is smaller than the number of protocol chips, one or more protocol chips may be connected to one memory address translation unit.

The mutual address translation units 123a and 123b have a function of mutually translating addresses used by the processor 131a and the processor 131b. The protocol chip 121a can store a request from the host machine in the memory 132b connected to the processor 131b and read out a response of the result of processing the request from the host machine from the memory 132b via the memory address translation unit 122a and the mutual address translation units 123a and 123b.

Similarly, the protocol chip 121b can store a request from the host machine in the memory 132a and read out a response of the result of processing the request from the host machine from the memory 132a via the memory address translation unit 122b and the mutual address translation units 123b and 123a.

Note that, in FIG. 11, the mutual address translation units 123a and 123b are provided in the interface units 120a and 120b, respectively, but the number of mutual address translation units in the interface unit is not limited to one, and can be any number. In particular, in FIG. 11, the mutual address translation units 123a and 123b are separately provided in the interface units 120a and 120b, respectively. However, the mutual address translation units 123a and 123b may be collectively provided as one mutual address translation unit, and may be provided only in one of the interface units 120a and 120b.

The processors 131a and 131b are connected to the memories 132a and 132b, respectively, and control the storage system 3 by executing the instruction code stored in the memory 132a or 132b.

The memories 132a and 132b store instruction codes executed by the processors 131a and 131b, respectively, and also store data necessary for executing the instruction codes. In addition, data transmitted from the host machine through the protocol chip 121a or 121b may be temporarily stored, or data transmitted to the host machine through the protocol chip 121a or 121b may be temporarily stored. In particular, the memory 132a or the memory 132b stores a request from the host machine such as a data read (Read) request and a data storing (Write) request which are received by the protocol chip from the host machine with respect to the storage system, and also stores a response of the result of processing the request from the host machine by the processor 131a or 131b.

In FIG. 11, the processors 131a and 131b and the memories 132a and 132b are provided in the processor board units 130a and 130b, respectively, but the number of processors and memories in the processor board unit is not limited to one and can be any number.

The mutual address translation units 133a and 133b have a function of mutually translating addresses used by the processor 131a and the processor 131b. The processor 131a can access an arbitrary address of the memory 132b via the mutual address translation units 133a and 133b. Similarly, the processor 131b can access an arbitrary address of the memory 132a via the mutual address translation units 133b and 133a.

In FIG. 11, the mutual address translation units 133a and 133b are provided in the processor board units 130a and 130b, respectively, but the number of mutual address translation units in the processor board unit is not limited to one and can be any number. In particular, in FIG. 11, the mutual address translation units 133a and 133b are separately provided in the processor board units 130a and 130b, respectively. However, the mutual address translation units 133a and 133b may be collectively provided as one mutual address translation unit, and may be provided in only one of the processor board units 130a and 130b.

The drive box 140 includes two backend switches 141a and 141b and eight storage devices 142a to 142b. In FIG. 11, the storage system 3 includes one drive box 140, but the number of drive boxes in the storage system is not limited to one and can be any number.

The backend switches 141a and 141b connect each of the processors 131a and 131b to eight storage devices 142a to 142h, and perform switching processing of data transmission between the processors 131a and 131b and the eight storage devices 142a to 142h according to a protocol of data transmission between the processors 131a and 131b and the storage devices 142a to 142h. In FIG. 11, two backend switches 141a and 141b are provided in the drive box 140, but the number of backend switches in the drive box is not limited to two, and can be any number.

The storage devices 142a to 142h store and hold data transmitted by the host machine to be stored in the storage system 3. In FIG. 11, eight storage devices 142a to 142h are provided in the drive box, but the number of storage devices in the drive box is not limited to eight, and can be any number.

As illustrated in FIG. 11, by providing the mutual address translation units 123a and 123b in the interface units 120a and 120b, respectively, even if any of the processor board units 130a and 130b is unavailable due to fault or replacement, the protocol chips 121a and 121b of any of the interface units 120a and 120b can access the memories 132a and 132b of the operating processor board unit 130a or 130b, respectively, and can continue communication with the host machine.

In FIG. 11, in the first processing mode, the storage system 3 stores the Read request and the Write request from the host machine received by the protocol chip 121a in the memory 132a of the processor board unit 130a connected to the interface unit 120a including the protocol chip 121a, and reads out a response of the result of processing the request from the host machine from the memory 132a.

In addition, in the second processing mode, the storage system 3 stores a Read request and a Write request from the host machine received by the protocol chip 121a in the memory 132b included in the processor board unit 130b connected through the interface unit 120b different from the interface unit 120a including the protocol chip, and reads out a response of the result of processing the request from the host machine from the memory 132b.

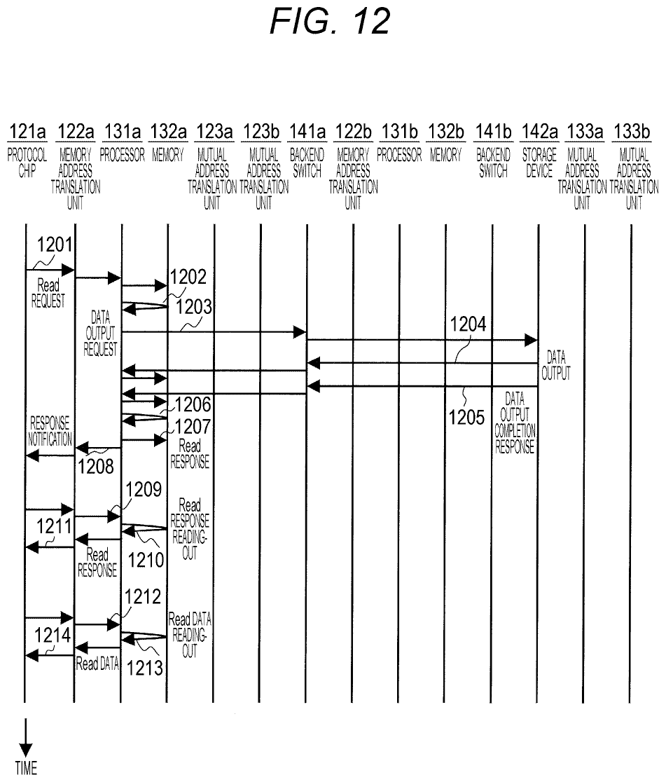

A state of this operation will be described with reference to FIGS. 12, 13, 14, and 15.

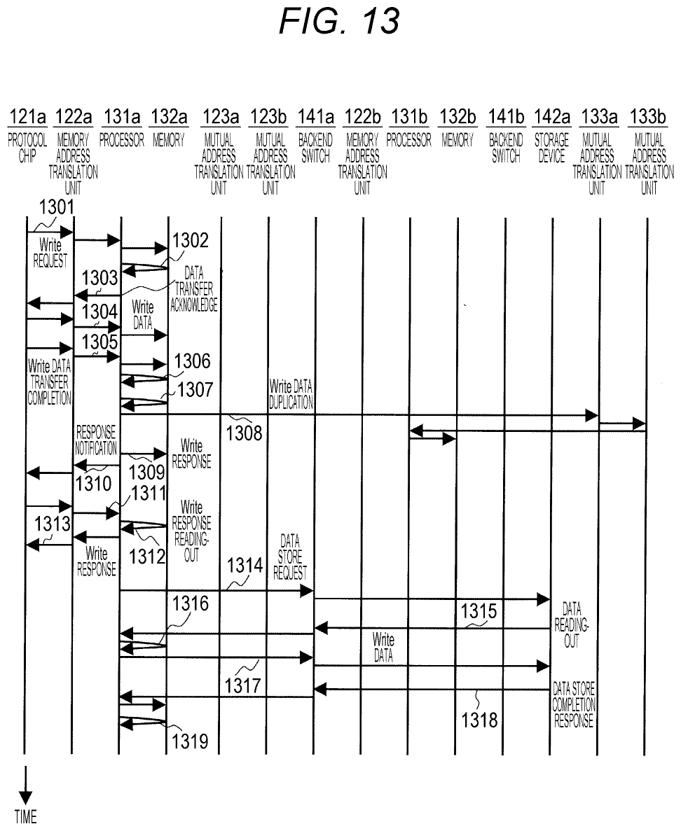

FIG. 12 is an example of a processing sequence in a case where the storage system 3 receives a Read request from the host machine in the first processing mode. In FIG. 12, each vertical line indicates a time order of a request or a response transmitted or received by a part described above. It is assumed that the time progresses from the top to the bottom in the drawing (the same applies to FIGS. 13, 14, and 15 below).

In FIG. 12, when receiving a Read request from a host machine (not illustrated), the protocol chip 121a of the interface unit 120a designates an address indicating the memory 132a as a storing destination and transmits the request from the host machine to the memory address translation unit 122a (1201).

In the first processing mode, by setting the address translation function of the memory address translation unit 122a to be ineffective, the memory address translation unit 122a transmits the request, which is transmitted by the protocol chip 121a from the host machine in which the address of the memory 132a is designated as the storing destination, to the processor 131a of the processor board unit 130a without performing address translation as it is.

The processor 131a stores, in the memory 132a, the request from the host machine, which is transmitted from the memory address translation unit 122a and designated with the address of the memory 132a as the storing destination, according to the designated address. The process of storing into the memory 132a by the processor 131a may be performed by causing the processor 131a to execute some kind of instruction code, or may be performed by providing a hardware mechanism for automatically storing in the memory 132a according to a designated address in the processor 131a.

Next, the processor 131a reads out the request, which is from the host machine transmitted from the protocol chip 121a, from the memory 132a and starts the processing (1202). If the request from the host machine read out from the memory 132a is a Read request, the processor 131a determines in which of the storage devices 142a to 142h the requested data is held, generates a data output request to the storage device, that is, the storage device 142a in the example of FIG. 12, and transmits the data output request via the backend switch 141a (1203).

The storage device 142a acquires the requested data from an internal storage element or a storage media, and stores the data in the memory 132a via the backend switch 141a and the processor 131a (1204). Furthermore, the storage device 142a generates a data output completion response indicating that the requested data has been successfully stored in the memory 132a, and stores the data output completion response in the memory 132a similarly via the backend switch 141a and the processor 131a (1205).

The process of storing the data from the storage device 142a and the data output completion response via the processor 131a into the memory 132a may be performed by causing the processor 131a to execute some kind of instruction code, or may be performed by providing a hardware mechanism that automatically stores the data in the memory 132a in the processor 131a.

Next, the processor 131a reads out the data output completion response written from the storage device 142a to the memory 132a from the memory 132a (1206). In accordance with the read-out data output completion response, the processor 131a generates a Read response to be transmitted to the host machine, and stores the Read response in the memory 132a (1207). Thereafter, the processor 131a generates a response notification notifying the protocol chip 121a that the Read response has been stored in the memory 132a, and transmits the response notification to the protocol chip 121a via the memory address translation unit 122a (1208).

When receiving the response notification from the processor 131a, the protocol chip 121a designates an address indicating the memory 132a as a source of read out, and transmits a read out request of the Read response to the memory address translation unit 122a. In the first processing mode, by setting the address translation function of the memory address translation unit 122a to be ineffective, the memory address translation unit 122a transmits the read out request of the Read response, which is transmitted by the protocol chip 121a and in which the address of the memory 132a is designated as the source of read out, to the processor 131a without performing address translation as it is (1209). When receiving the Read response read out request from the protocol chip 121a, the processor 131a reads out the Read response from the memory 132a (1210) and transmits the Read response to the protocol chip 121a via the memory address translation unit 122a (1211).

The Read response read out from the memory 132a by the processor 131a according to the Read response read out request from the protocol chip 121a may be performed by causing the processor 131a to execute some kind of instruction code, or may be performed by providing a hardware mechanism that automatically reads out from the memory 132a in the processor 131a.

When receiving the Read response from the processor 131a, the protocol chip 121a transmits a Read data read out request for extracting Read data from the memory 132a to the processor 131a via the memory address translation unit 122a according to the response content (1212). In accordance with the transmitted Read data read out request, the processor 131a reads out the Read data (1213), and transmits the read-out Read data to the protocol chip 121a via the memory address translation unit 122a (1214).

The Read data read out from the memory 132a by the processor 131a according to the Read data read out request from the protocol chip 121a may be performed by causing the processor 131a to execute some kind of instruction code, or may be performed by providing a hardware mechanism that automatically reads out data from the memory 132a in the processor 131a. When receiving the Read data from the processor 131a, the protocol chip 121a transmits the Read data to a host machine (not illustrated).

FIG. 13 is an example of a processing sequence in a case where the storage system 3 receives a Write request from the host machine in the first processing mode.

In FIG. 13, when receiving a Write request from a host machine (not illustrated), the protocol chip 121a designates an address indicating the memory 132a as a storing destination and transmits the request from the host machine to the memory address translation unit 122a (1301). In the first processing mode, by setting the address translation function of the memory address translation unit 122a to be ineffective, the memory address translation unit 122a transmits the request, which is transmitted by the protocol chip 121a from the host machine in which the address of the memory 132a is designated as the storing destination, to the processor 131a without performing address translation as it is.

The processor 131a stores, in the memory 132a, the request from the host machine, which is transmitted from the memory address translation unit 122a and designated with the address of the memory 132a as the storing destination, according to the designated address. The process of storing into the memory 132a by the processor 131a may be performed by causing the processor 131a to execute some kind of instruction code, or may be performed by providing a hardware mechanism for automatically storing in the memory 132a according to a designated address in the processor 131a.

Next, the processor 131a reads out the request, which is from the host machine transmitted from the protocol chip 121a, from the memory 132a and starts the processing (1302). If the request from the host machine read out from the memory 132a is a Write request, the processor 131a prepares to receive the Write data and transmits a transfer acknowledge of the Write data to the protocol chip 121a via the memory address translation unit 122a (1303).

The protocol chip 121a that has received the Write data transfer acknowledge transmits the Write data transfer acknowledge to the host machine, and receives the Write data from the host machine. The protocol chip 121a stores the Write data received from the host machine in the memory 132a via the memory address translation unit 122a and the processor 131a (1304).

Further, when receiving a signal indicating Write data transfer completion from the host machine, the protocol chip 121a stores the Write data transfer completion in the memory 132a similarly via the memory address translation unit 122a and the processor 131a (1305). The process of storing the Write data and the Write data transfer completion into the memory 132a via the processor 131a may be performed by causing the processor 131a to execute some kind of instruction code, or may be performed by providing a hardware mechanism for automatically storing the data in the memory 132a in the processor 131a.

Next, the processor 131a reads out and checks the Write data transfer completion stored in the memory 132a (1306). Thereafter, the processor 131a reads out the Write data from the memory 132a (1307), and transmits the Write data to be stored in the memory 132b via the mutual address translation units 133a and 133b and the processor 131b (1308).

This is because the Write data is to be duplicated in the memory 132a and the memory 132b, and even if the one of memory 132a or 132b becomes inaccessible due to a fault or stopping power supply, or the processor 131a or 131b stops operating, the Write data received from the host machine is not lost.

In addition, the process of storing the Write data in the memory 132b via the processor 131b may be performed by causing the processor 131b to execute some kind of instruction code, or may be performed by providing a hardware mechanism for automatically storing the Write data in the memory 132b in the processor 131b.

When the process of duplicating the Write data is completed, the processor 131a generates a Write response and stores the Write response in the memory 132a (1309). Thereafter, the processor 131a generates a response notification notifying the protocol chip 121a that the Write response has been stored in the memory 132a, and transmits the response notification to the protocol chip 121a via the memory address translation unit 122a (1310).

When receiving the response notification from the processor 131a, the protocol chip 121a designates an address indicating the memory 132a as a source of read out, and transmits a read out request of the Write response to the memory address translation unit 122a. In the first processing mode, by setting the address translation function of the memory address translation unit 122a to be ineffective, the memory address translation unit 122a transmits the read out request of the Write response, which is transmitted by the protocol chip 121a and in which the address of the memory 132a is designated as the source of read out, to the processor 131a without performing address translation as it is (1311). When receiving the Write response read out request from the protocol chip 121a, the processor 131a reads out the Write response from the memory 132a (1312) and transmits the Write response to the protocol chip 121a via the memory address translation unit 122a (1313).

The Write response read out from the memory 132a by the processor 131a according to the Write response read out request from the protocol chip 121a may be performed by causing the processor 131a to execute some kind of instruction code, or may be performed by providing a hardware mechanism that automatically reads out from the memory 132a in the processor 131a.

When receiving the Write response from the processor 131a, the protocol chip 121a notifies the host machine that the Write processing has been completed.

Next, the processor 131a determines the storage devices 142a to 142h in which the Write data stored in the memory 132a is stored. In FIG. 13, it is assumed that the processor 131a determines to store the Write data stored in the memory 132a in the storage device 142a. Therefore, the processor 131a generates a data store request and transmits the data store request to the storage device 142a via the backend switch 141a (1314).

The storage device 142a that has received the data store request transmits a data read request of the Write data to the processor 131a via the backend switch 141a (1315). When receiving the data read request, the processor 131a reads out the Write data from the memory 132a (1316), transmits the Write data to the storage device 142a via the backend switch 141a, and stores the Write data (1317).

The reading-out of the Write data from the memory 132a by the processor 131a according to the data read out request of the Write data from the storage device 142a may be performed by causing the processor 131a to execute some kind of instruction code, or may be performed by providing a hardware mechanism for automatically reading out the Write data from the memory 132a in response to the read out request of the Write data in the processor 131a.

When receiving Write data, the storage device 142a stores the received Write data in an internal storage element or storage media. When the storing of the Write data into the internal storage element or storage media is completed, the storage device 142a generates a data store completion response and stores the data store completion response in the memory 132a via the backend switch 141a and the processor 131a (1318).

The process of storing the data store completion response into the memory 132a via the processor 131a may be performed by causing the processor 131a to execute some kind of instruction code, or may be performed by providing a hardware mechanism for automatically storing the data in the memory 132a in the processor 131a. Finally, the processor 131a reads out the data store completion response from the memory 132a and checks it (1319).

The above is the operation in the storage system 3 when there is a Read request or a Write request from the host machine in the first processing mode in which the request from the host machine and the response of the result of processing the request from the host machine are stored in the memory 132a. In a case where the memory 132a cannot be accessed due to a fault or stopping power supply, or in a case where the processor 131a stops operating and the storing or reading-out with respect to the memory 132a cannot be performed, or in a case where the entire processor board unit 130a becomes unavailable due to a fault or replacement, a second processing mode of storing a request from the host machine and a response of the result of processing the request from the host machine in the memory 132b is applied instead of the memory 132a.

By applying the second processing mode, it is possible to continue the processing of the request from the host machine even in a case the memory 132a cannot be accessed due to a fault or stopping power supply, the processor 131a stops operating and cannot be stored or read out with respect to the memory 132a, or even in a case where the entire processor board unit 130a becomes unavailable due to a fault or replacement.

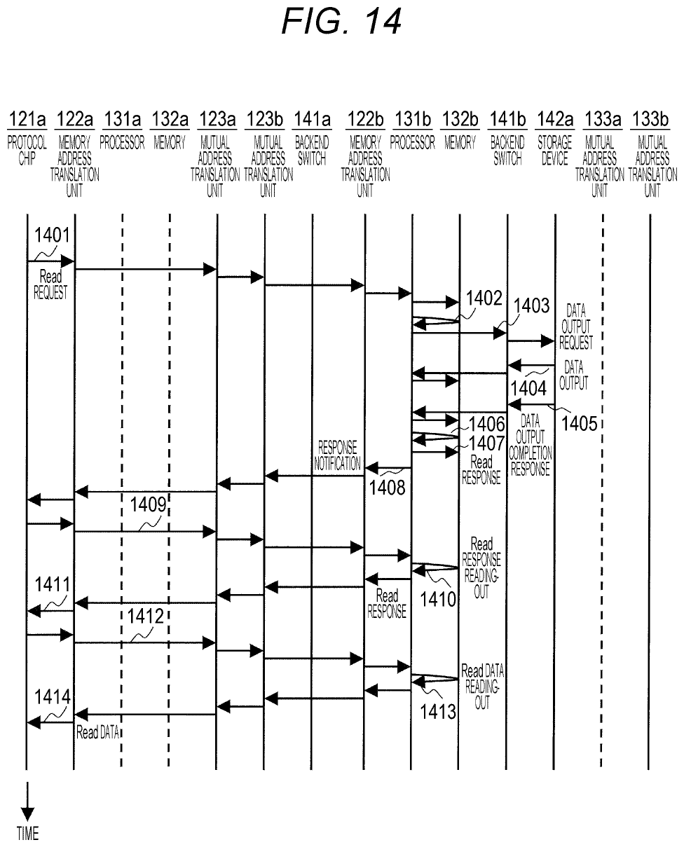

FIG. 14 is an example of a processing sequence in the storage system 3 when a Read request is received from the host machine in a case where the second processing mode is applied.

In FIG. 14, when receiving a Read request from a host machine (not illustrated), the protocol chip 121a designates an address indicating the memory 132a as a storing destination and transmits the request from the host machine to the memory address translation unit 122a (1401).

In the second processing mode, by setting the address translation function of the memory address translation unit 122a to be effective, the memory address translation unit 122a translates the address associated with the request from the host machine transmitted by the protocol chip 121a designating the memory 132a as the storing destination into the address designating the memory 132b. Further, after the address translation is performed so as to designate the memory 132b, the request from the host machine is not transmitted to the processor 131a, but transmitted to the processor 131b via the mutual address translation units 123a and 123b and the memory address translation unit 122b, and stored in the memory 132b.

The process of storing into the memory 132b by the processor 131b may be performed by causing the processor 131b to execute some kind of instruction code, or may be performed by providing a hardware mechanism for automatically storing in the memory 132b according to a designated address in the processor 131b.

Next, the processor 131b reads out, from the memory 132b, the request from the host machine transmitted from the protocol chip 121a and starts the processing (1402). If the request from the host machine read out from the memory 132b is a Read request, the processor 131b determines in which of the storage devices 142a to 142h the requested data is held, generates a data output request to the storage device, that is, the storage device 142a in the example of FIG. 14, and transmits the data output request via the backend switch 141b (1403).

The storage device 142a acquires the requested data from an internal storage element or a storage media, and stores the data in the memory 132b via the backend switch 141b and the processor 131b (1404). Furthermore, the storage device 142a generates a data output completion response indicating that the requested data has been successfully stored in the memory 132b, and stores the data output completion response in the memory 132b similarly via the backend switch 141b and the processor 131b (1405).

The process of storing the data from the storage device 142a and the data output completion response via the processor 131b into the memory 132b may be performed by causing the processor 131b to execute some kind of instruction code, or may be performed by providing a hardware mechanism that automatically stores the data in the memory 132b in the processor 131b.

Next, the processor 131b reads out the data output completion response written from the storage device 142a to the memory 132b from the memory 132b (1406). In accordance with the read-out data output completion response, the processor 131b generates a Read response to be transmitted to the host machine, and stores the Read response in the memory 132b (1407). Thereafter, the processor 131b generates a response notification notifying the protocol chip 121a that the Read response has been stored in the memory 132b, and transmits the response notification to the protocol chip 121a via the memory address translation unit 122b, the mutual address translation units 123b and 123a, and the memory address translation unit 122a (1408).

When receiving the response notification from the processor 131b, the protocol chip 121a designates an address indicating the memory 132a as a source of read out, and transmits a read out request of the Read response to the memory address translation unit 122a.

In the second processing mode, by setting the address translation function of the memory address translation unit 122a to be effective, the memory address translation unit 122a translates the address designating the memory 132a as the read-out source into the address designating the memory 132b for the read out request of the Read response transmitted by the protocol chip 121a. Further, after the address translation is performed so as to designate the memory 132b, the read out request of the Read response is not transmitted to the processor 131a but transmitted to the processor 131b via the mutual address translation units 123a and 123b and the memory address translation unit 122b (1409).

When receiving the Read response read out request from the protocol chip 121a, the processor 131b reads out the Read response from the memory 132b (1410) and transmits the Read response to the protocol chip 121a via the memory address translation unit 122b, the mutual address translation units 123b and 123a, and the memory address translation unit 122a (1411).

The Read response read out from the memory 132b by the processor 131b according to the Read response read out request from the protocol chip 121a may be performed by causing the processor 131b to execute some kind of instruction code, or may be performed by providing a hardware mechanism that automatically reads out from the memory 132b in the processor 131b.

When receiving the Read response from the processor 131b, the protocol chip 121a designates an address indicating the memory 132a as a read-out source according to the response content, generates a Read data read out request for extracting data, and transmits the Read data read out request to the memory address translation unit 122a.

In the second processing mode, by setting the address translation function of the memory address translation unit 122a to be effective, the memory address translation unit 122a translates the address designating the memory 132a as the read-out source into the address designating the memory 132b for the read out request of the Read data transmitted by the protocol chip 121a. Further, after the address translation is performed so as to designate the memory 132b, the read out request of the Read data is not transmitted to the processor 131a but transmitted to the processor 131b via the mutual address translation units 123a and 123b and the memory address translation unit 122b (1412).

In accordance with the transmitted Read data read out request, the processor 131b reads out the Read data (1413), and transmits the read-out Read data to the protocol chip 121a via the memory address translation unit 122b, the mutual address translation units 123b and 123a, and the memory address translation unit 122a (1414).

The Read data read out from the memory 132b by the processor 131b according to the Read data read out request from the protocol chip 121a may be performed by causing the processor 131b to execute some kind of instruction code, or may be performed by providing a hardware mechanism that automatically reads out data from the memory 132b in the processor 131b. When receiving the Read data from the processor 131b, the protocol chip 121a transmits the Read data to a host machine (not illustrated).

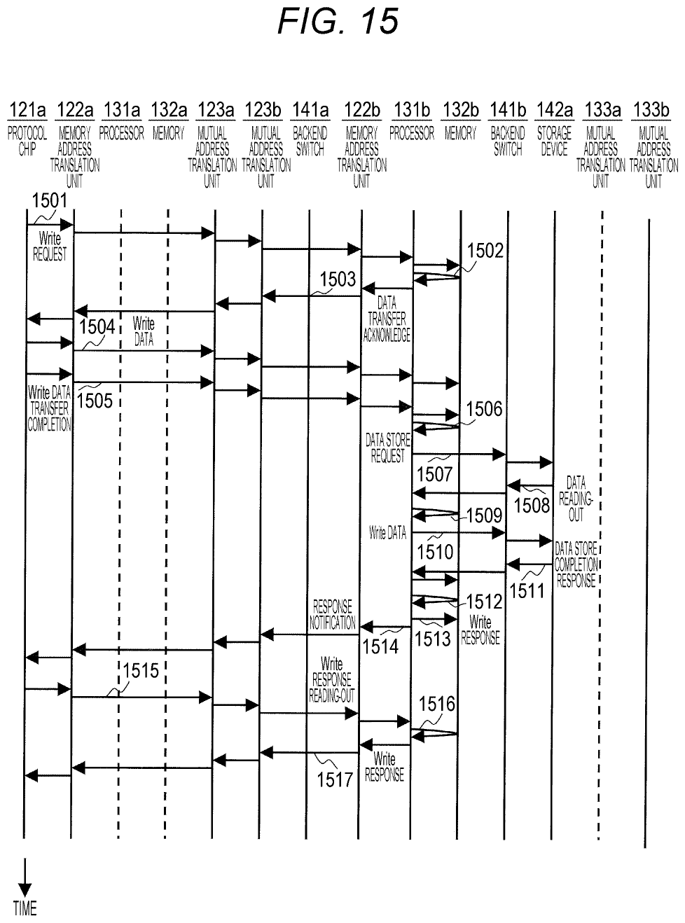

FIG. 15 is an example of a processing sequence in a case where the storage system 3 receives a Write request from the host machine in the second processing mode.

In FIG. 15, when receiving a Write request from a host machine (not illustrated), the protocol chip 121a designates an address indicating the memory 132a as a storing destination and transmits the request from the host machine to the memory address translation unit 122a (1501).

In the second processing mode, by setting the address translation function of the memory address translation unit 122a to be effective, the memory address translation unit 122a translates the address associated with the request from the host machine transmitted by the protocol chip 121a designating the memory 132a as the storing destination into the address designating the memory 132b. Further, after the address translation is performed so as to designate the memory 132b, the request from the host machine is not transmitted to the processor 131a, but transmitted to the processor 131b via the mutual address translation units 123a and 123b and the memory address translation unit 122b, and stored in the memory 132b.

The process of storing into the memory 132b by the processor 131b may be performed by causing the processor 131b to execute some kind of instruction code, or may be performed by providing a hardware mechanism for automatically storing in the memory 132b according to a designated address in the processor 131b.

Next, the processor 131b reads out, from the memory 132b, the request from the host machine transmitted from the protocol chip 121a and starts the processing (1502). If the request from the host machine read out from the memory 132b is a Write request, the processor 131b prepares to receive the Write data and transmits a transfer acknowledge of the Write data to the protocol chip 121a via the memory address translation unit 122b, the mutual address translation units 123b and 123a, and the memory address translation unit 122a (1503).

The protocol chip 121a that has received the Write data transfer acknowledge transmits the Write data transfer acknowledge to the host machine, and receives the Write data from the host machine. The protocol chip 121a stores the Write data received from the host machine in the memory 132b via the memory address translation unit 122a, the mutual address translation units 123a and 123b, the memory address translation unit 122b, and the processor 131b (1504).

Further, when receiving a signal indicating Write data transfer completion from the host machine, the protocol chip 121a stores the Write data transfer completion in the memory 132b similarly via the memory address translation unit 122a, the mutual address translation units 123a and 123b, the memory address translation unit 122b, and the processor 131b (1505).

The process of storing the Write data and the Write data transfer completion into the memory 132b via the processor 131b may be performed by causing the processor 131b to execute some kind of instruction code, or may be performed by providing a hardware mechanism for automatically storing the data in the memory 132b in the processor 131b.

Next, the processor 131b reads out and checks the Write data transfer completion stored in the memory 132b (1506). Thereafter, in the second processing mode, the Write data is not duplicated in the memory 132a and the memory 132b as in the first processing mode in consideration of the possibility that the memory 132a cannot be accessed due to a fault or the like.

Instead, the Write data is directly stored in any one of the storage devices 142a to 142h, and a Write response is returned to the host machine. That is, next, the processor 131b determines the storage devices 142a to 142h in which the Write data stored in the memory 132b is stored.

In FIG. 15, it is assumed that the processor 131b determines to store the Write data stored in the memory 132b in the storage device 142a. Therefore, the processor 131b generates a data store request and transmits the data store request to the storage device 142a via the backend switch 141b (1507). The storage device 142a that has received the data store request transmits a data read request of the Write data to the processor 131b via the backend switch 141b (1508).

When receiving the data read request, the processor 131b reads out the Write data from the memory 132b (1509), transmits the Write data to the storage device 142a via the backend switch 141b, and stores the Write data (1510). The reading-out of the Write data from the memory 132b by the processor 131b according to the data read out request of the Write data from the storage device 142a may be performed by causing the processor 131b to execute some kind of instruction code, or may be performed by providing a hardware mechanism for automatically reading out the Write data from the memory 132b in response to the read out request of the Write data in the processor 131b.

When receiving Write data, the storage device 142a stores the received Write data in an internal storage element or storage media. When the storing of the Write data into the internal storage element or storage media is completed, the storage device 142a generates a data store completion response and stores the data store completion response in the memory 132b via the backend switch 141b and the processor 131b (1511).

The process of storing the data store completion response into the memory 132b via the processor 131b may be performed by causing the processor 131b to execute some kind of instruction code, or may be performed by providing a hardware mechanism for automatically storing the Write data in the memory 132b in the processor 131b.

Thereafter, the processor 131b reads out a data store completion response from the memory 132b and checks it (1512). The processor 131b that has checked the data store completion response generates a Write response and stores the Write response in the memory 132b (1513). Thereafter, the processor 131b generates a response notification notifying the protocol chip 121a that the Write response has been stored in the memory 132b, and transmits the response notification to the protocol chip 121a via the memory address translation unit 122b, the mutual address translation units 123b and 123a, and the memory address translation unit 122a (1514).

When receiving the response notification from the processor 131b, the protocol chip 121a designates an address indicating the memory 132a as a source of read out, and transmits a read out request of the Write response to the memory address translation unit 122a.

In the second processing mode, by setting the address translation function of the memory address translation unit 122a to be effective, the memory address translation unit 122a translates the address designating the memory 132a as the read-out source into the address designating the memory 132b for the read out request of the Write response transmitted by the protocol chip 121a, and transmits the address to the processor 131b via the mutual address translation units 105a and 105b and the memory address translation unit 122b (1515).

When receiving the Write response read out request from the protocol chip 121a, the processor 131b reads out the Write response from the memory 132b (1516) and transmits the Read response to the protocol chip 121a via the memory address translation unit 122b, the mutual address translation units 123b and 123a, and the memory address translation unit 122a (1517).

The Write response read out from the memory 132b by the processor 131b according to the Write response read out request from the protocol chip 121a may be performed by causing the processor 131b to execute some kind of instruction code, or may be performed by providing a hardware mechanism that automatically reads out from the memory 132b in the processor 131b. When receiving the Write response from the processor 131b, the protocol chip 121a notifies the host machine that the Write processing has been completed.

The above is the operation in the storage system 3 when there is a Read request or a Write request from the host machine in the second processing mode in which the request from the host machine and the response of the result of processing the request from the host machine are stored in the memory 132b. By applying the second processing mode, it is possible to continue the processing of the request from the host machine even in a case where the memory 132a cannot be accessed due to a fault or stopping power supply, the processor 131a stops operating and cannot be stored or read out with respect to the memory 132a, or the entire processor board unit 130a becomes unavailable due to a fault or replacement.

### Fourth Embodiment

A fourth embodiment will be described with reference to FIGS. 1, 19, and 20. In the fourth embodiment, the structure of the storage system, the processing of the request from the host machine, and the response of the processed result are the same as those in the first embodiment. Note that the present embodiment can be applied to the configuration example illustrated in FIG. 6 or 11. In the fourth embodiment, regarding the request from the host machine for which the processor 103a has not completed the processing while being in the first processing mode, the processor 103b notifies the host machine that the processing of the request has been interrupted in the second processing mode.

As described above, by notifying the host machine that the processing of the request has been interrupted, the host machine can quickly find that the processing has been interrupted without detecting that a response has not been returned from the storage system within a certain period of time, and can request the processing again as necessary. By doing so, the processing of the host machine proceeds without delay. In addition, it is also possible to prevent the host machine from stopping the processing of the host machine itself due to erroneous determination that the storage system is stopped.

In the fourth embodiment, the configuration of the storage system 1 is as illustrated in FIG. 1.

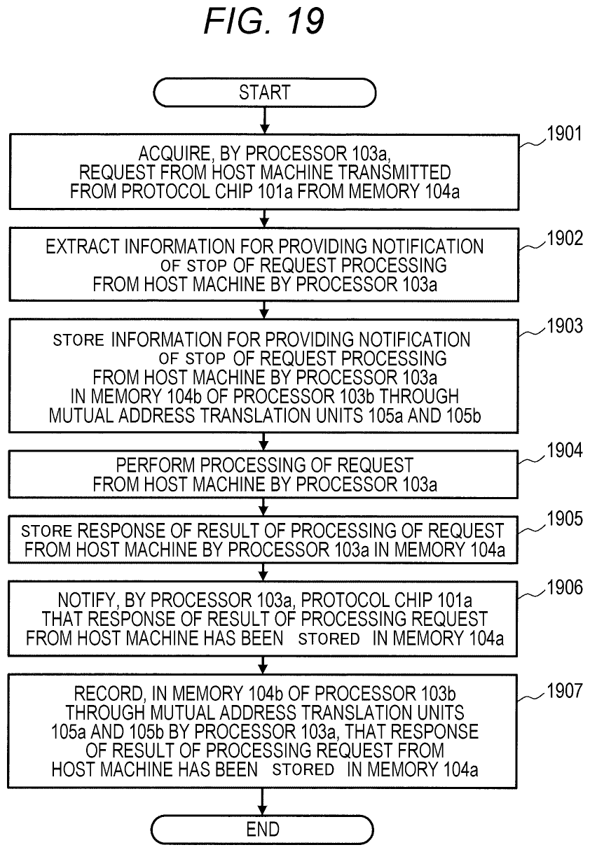

FIG. 19 illustrates processing performed by the processor 103a when the storage system 1 is in the first processing mode in the fourth embodiment. In FIG. 19, the processor 103a extracts, from the memory 104a, the request from the host machine transmitted from the protocol chip 101a and stored in the memory 104a (step 1901).

Next, the processor 103a extracts, from the request from the host machine extracted from the memory 104a, information for notifying the host machine that the processing of the request has been interrupted (step 1902). The information for notifying the host machine that the processing of the request has been interrupted is, for example, a host name (identifier) of the host machine, a volume number or an intra-volume logical address number for identifying a storage area in the storage system that is a target of the request, a type of request of the Read request or the Write request, a tag number assigned by the host machine to distinguish the request from other requests, or a session number for identifying a series of communication between the protocol chip 101a and the host machine.

Next, the processor 103a stores, in the memory 104b of the processor 103b, the extracted information for providing notification that the processing of the request from the host machine has been interrupted, through the mutual address translation units 105a and 105b (step 1903). Thereafter, the processor 103a processes the request from the host machine (step 1904).

When the processing of the request from the host machine is completed, the processor 103a stores a response of the result of processing the request from the host machine in the memory 104a (step 1905). Next, the processor 103a notifies the protocol chip 101a that a response of the result of processing the request from the host machine has been stored in the memory 104a, and causes the protocol chip 101a to return the response of the result of processing to the host machine (step 1906).

Finally, when the processing up to step 1906 can be completed without stopping, in step 1907, the processor 103a stores the response of the result of processing the request from the host machine in the memory 104a, and records the response in the memory 104b of the processor 103b via the mutual address translation units 105a and 105b that the response is returned to the host machine by the protocol chip 101a.

The recording in the memory 104b may be performed by some marking for identifying the request from the host machine, information indicating that a response of the result of processing the request from the host machine is returned to the host machine by the protocol chip 101a may be added to the information stored in step 1903 for providing notification that the processing of the request from the host machine has been interrupted, or information stored in step 1903 for providing notification that the processing of the request from the host machine has been interrupted may be deleted on the memory 104b.

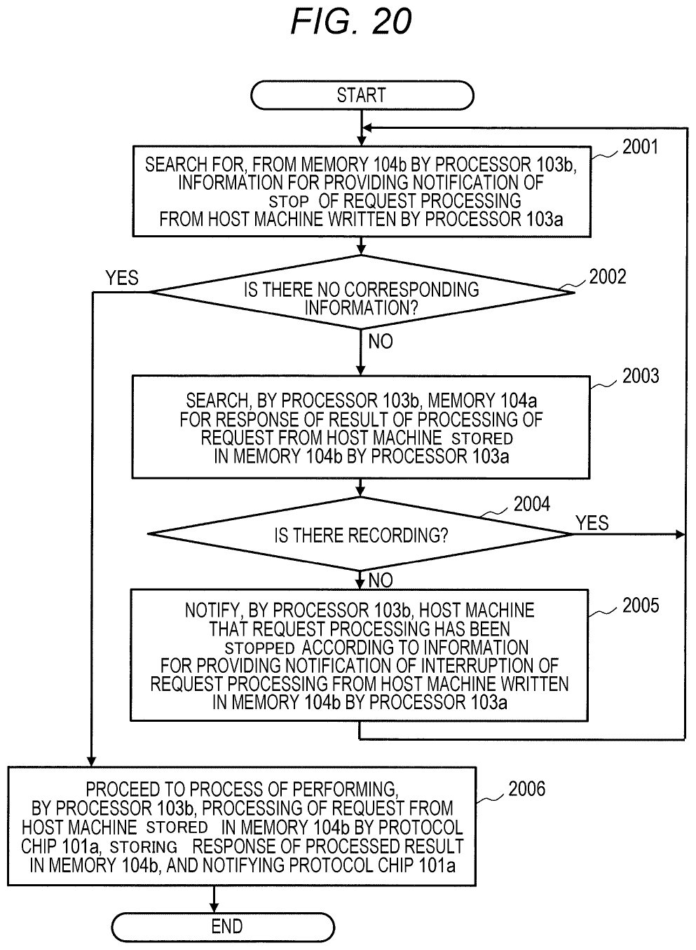

FIG. 20 illustrates processing in which, in the second processing mode, the processor 103b extracts information stored in the memory 104b for providing notification that the processor 103a has interrupted the processing of the request from the host machine and notifies the host machine that the processing of the request has been interrupted.

In FIG. 20, in the second processing mode, the processor 103b searches the memory 104b for information for providing notification that the processor 103a has interrupted the processing of the request from the host machine stored in the memory 104b (step 2001). As a result of the search, when there is no information in the memory 104b (step 2002: NO), the process proceeds to a process of extracting, from the memory 104b, the request from the host machine stored in the memory 104b by the protocol chip 101a, storing a response of the result of processing the request from the host machine in the memory 104b, notifying the protocol chip 101a of the response, and returning the response of the result of processing the request to the host machine in the second processing mode (step 2006).

When the information for providing notification that the processing of the request from the host machine has been interrupted is stored in the memory 104b (step 2002: YES), the process proceeds to step 2003, and the processor 103a searches the memory 104b for a record in which a response of the result of processing the request from the host machine is stored in the memory 104a. As a result of the search, if there is the record (step 2004: YES), the process returns to step 2001, and the search in the memory 104b is continued as to whether there is information stored by the processor 103a for providing notification of the interruption of the processing of the request from the host machine.

As a result of the search, when there is no record (step 2004: NO), the process proceeds to step 2005, and the host machine is notified that the processing of the request from the host machine has been interrupted by using the information stored in the memory 104b for providing notification that the processing of the request from the host machine has been interrupted. Thereafter, the process returns to step 2001, and the search in the memory 104b is continued as to whether there is information stored by the processor 103a for providing notification of the interruption of the processing of the request from the host machine.

As described above, since it is possible to notify the host machine that the processing of the request has been interrupted, the host machine quickly recognizes that the processing has been interrupted without detecting that a response is not returned from the storage system within a certain period of time, and can request the processing again as necessary, and the processing of the host machine proceeds without delay. In addition, it is also possible to prevent the host machine from stopping the processing of the host machine itself due to erroneous determination that the storage system is stopped.

### Fifth Embodiment

A fifth embodiment will be described with reference to FIGS. 1, 21, 22, 23, and 24. In the fifth embodiment, in the first processing mode, the memory address translation unit 102a stores a request from the host machine in the memory 104a of the processor 103a that performs processing in the first processing mode, and stores a copy thereof in the memory 104b of the processor 103b that performs processing in the second processing mode. In addition, the processor 103a stores a response of the result of processing the request from the host machine and the like in the memory 104a, and stores a copy thereof in the memory 104b.

With this configuration, when the processor 103a transitions from the first processing mode to the second processing mode, the processor 103b identifies the request from the host machine that the processor 103a has not completed the processing by matching the request from the host machine stored in the memory 104b of the processor 103b with the response of the result of processing the request from the host machine. In a case where the response of the result of processing the request from the host machine is not stored, it is possible to process the request from the host machine again.

In the fifth embodiment, the structure of the storage system is the same as that of the storage system 1 illustrated in FIG. 1 in the first embodiment. Note that the present embodiment can be applied to the configuration example illustrated in FIG. 6 or 11.

In the fifth embodiment, since the memory address translation function is set to be ineffective in the first processing mode, the memory address translation unit 102a transmits, to the processor 103a, a request from the host machine to which the protocol chip designates the address of the memory 104a as the storing destination and transmits the request without performing address translation, and stores the request in the memory 104a.

In addition, in the fifth embodiment, the memory address translation unit 102a subsequently duplicates a request from the host machine, assigns an address of the memory 104b to be translated in a case where the memory address translation function is effective, transmits the address to the processor 103a, transmits the address to the processor 103b through the mutual address translation units 105a and 105b, and stores the address in the memory 104b.

Further, the processor 103a processes the request from the host machine, generates a response of the result of the processing, stores the response in the memory 104a, duplicates the response, transmits the response to the processor 103b through the mutual address translation units 105a and 105b, and stores the response in the memory 104b.

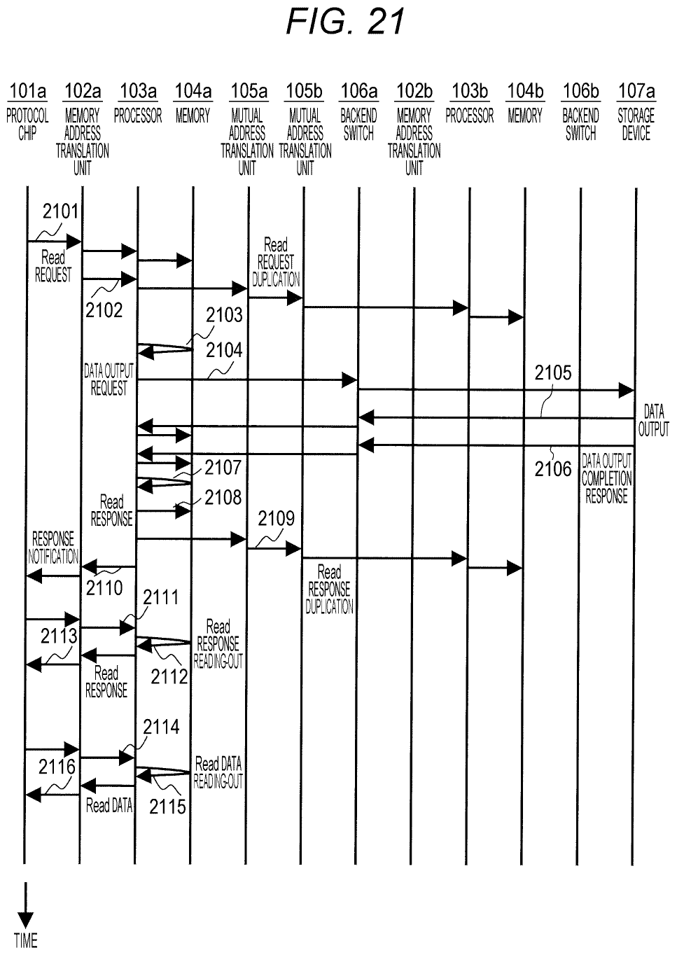

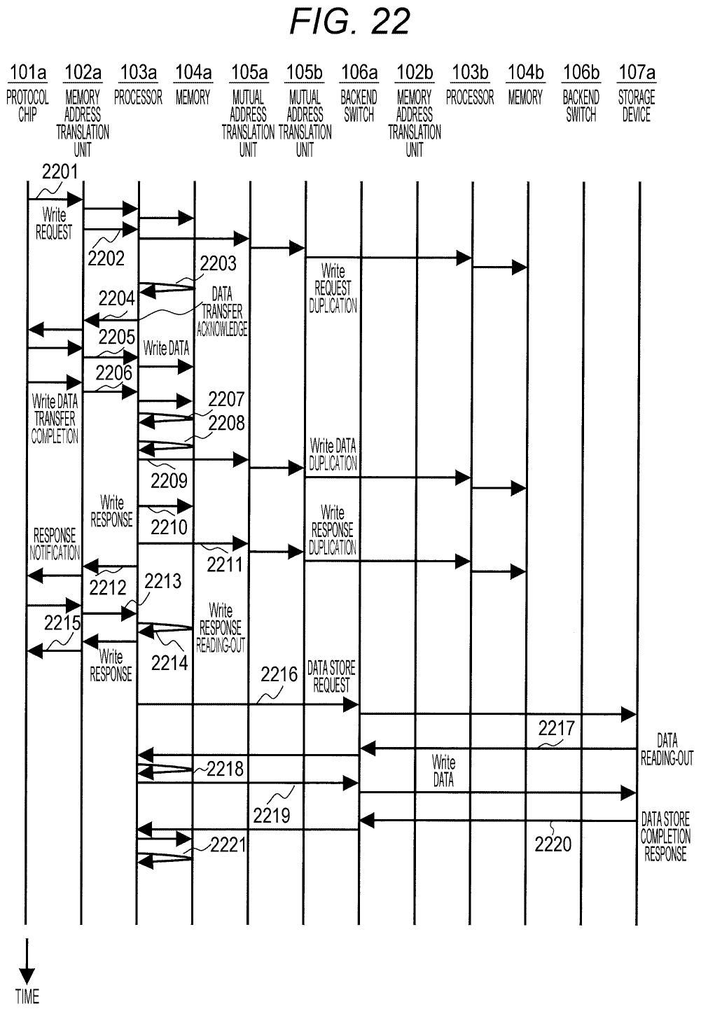

Hereinafter, an example of a processing sequence in the fifth embodiment of the present invention in the first processing mode will be described with reference to FIGS. 21 and 22.

FIG. 21 is an example of a processing sequence in a case where the storage system 1 receives a Read request from the host machine in the first processing mode in the fifth embodiment. In FIG. 21, each vertical line indicates a time order of a request or a response transmitted or received by a part described above. It is assumed that the time progresses from the top to the bottom in the drawing (the same applies to FIG. 22 below).

In FIG. 21, when receiving a Read request from a host machine (not illustrated), the protocol chip 101a designates an address indicating the memory 104a as a storing destination and transmits the request from the host machine to the memory address translation unit 102a (2101). In the first processing mode, by setting the address translation function of the memory address translation unit 102a to be ineffective, the memory address translation unit 102a transmits the request, which is transmitted by the protocol chip 101a from the host machine in which the address of the memory 104a is designated as the storing destination, to the processor 103a without performing address translation as it is.

In the fifth embodiment, the memory address translation unit 102a subsequently designates the address of the memory 104a as the storing destination, duplicates the request transmitted from the host machine to the processor 103a, newly designates the address of the memory 104b to be translated in a case where the address translation function is effective as the address of the storing destination, and similarly transmits the address to the processor 103a (2102).

The processor 103a stores, in the memory 104a, the request from the host machine in which the address of the memory 104a is designated as the storing destination. The process of storing into the memory 104a by the processor 103a may be performed by causing the processor 103a to execute some kind of instruction code, or may be performed by providing a hardware mechanism for automatically storing in the memory 104a according to a designated address in the processor 103a.

In addition, the processor 103a transmits, to the mutual address translation unit 105a, the request from the host machine, which is transmitted following the request from the host machine designated with the address of the memory 104a as the storing destination and designated with the address of the memory 104b, and stores the request in the memory 104b through the mutual address translation unit 105b and the processor 103b.

The process of causing the processor 103a to store, in the memory 104b, the request from the host machine designated with the address of the memory 104b as the storing destination via the mutual address translation units 105a and 105b and the processor 103b according to the designated address may be performed by causing the processor 103a to execute some kind of instruction code, or a hardware mechanism that automatically transmits the request to the mutual address translation unit 105a according to the designated address may be provided in the processor 103a.

Next, the processor 103a reads out, from the memory 104a, the request from the host machine transmitted from the protocol chip 101a and starts processing (2103). The flow of processing from the sequence 2103 to the sequence 2108 in which the processor 103a generates a Read response to be transmitted to the host machine and stores the Read response in the memory 104a is the same as the flow of processing from the sequence 202 to the sequence 207 in FIG. 2 of the first embodiment.

In the fifth embodiment, the processor 103a generates a Read response to be transmitted to the host machine and stores the Read response in the memory 104a in the sequence 2108, then duplicates the Read response, transmits the Read response to the processor 103b through the mutual address translation units 105a and 105b, and stores the Read response in the memory 104b (2109).

By doing so, after the processor 103b subsequently transitions to the second processing mode, the processor 103b can identify a case where the Read request from the host machine transmitted by the processor 103a from the protocol chip 101a is stored, but the Read response of the result of processing the request from the host machine is not stored, by retrieving the content of the memory 104b.

The processor 103a duplicates the Read response in the sequence 2109, stores the Read response in the memory 104b of the processor 103b, generates a response notification notifying the protocol chip 101a that the Read response has been stored in the memory 104a, and transmits the response notification to the protocol chip 101a via the memory address translation unit 102a (2110).

The processing from the sequence 2110 to the sequence 2116 in which the Read data is transmitted to the protocol chip 101a and returned to the host machine is the same as the flow of processing from the sequence 208 to the sequence 214 in FIG. 2 of the first embodiment. With the above flow of processing, the processing sequence in the case of receiving the Read request from the host machine is completed in the fifth embodiment.

FIG. 22 is an example of a processing sequence in a case where the storage system 1 receives a Write request from the host machine in the first processing mode in the fifth embodiment.

In FIG. 22, when receiving a Write request from a host machine (not illustrated), the protocol chip 101a designates an address indicating the memory 104a as a storing destination and transmits the request from the host machine to the memory address translation unit 102a (2201).

In the first processing mode, by setting the address translation function of the memory address translation unit 102a to be ineffective, the memory address translation unit 102a transmits the request, which is transmitted by the protocol chip 101a from the host machine in which the address of the memory 104a is designated as the storing destination, to the processor 103a without performing address translation as it is.

In the fifth embodiment, the memory address translation unit 102a subsequently designates the address of the memory 104a as the storing destination, duplicates the request transmitted from the host machine to the processor 103a, newly designates the address of the memory 104b to be translated in a case where the address translation function is effective as the address of the storing destination, and similarly transmits the address to the processor 103a (2202).

The processor 103a stores, in the memory 104a, the request from the host machine in which the address of the memory 104a is designated as the storing destination. The process of storing into the memory 104a by the processor 103a may be performed by causing the processor 103a to execute some kind of instruction code, or may be performed by providing a hardware mechanism for automatically storing in the memory 104a according to a designated address in the processor 103a.

In addition, the processor 103a transmits, to the mutual address translation unit 105a, the request from the host machine, which is transmitted following the request from the host machine designated with the address of the memory 104a as the storing destination and designated with the address of the memory 104b, and stores the request in the memory 104b through the mutual address translation unit 105b and the processor 103b.

The process of causing the processor 103a to store, in the memory 104b, the request from the host machine designated with the address of the memory 104b as the storing destination via the mutual address translation units 105a and 105b and the processor 103b according to the designated address may be performed by causing the processor 103a to execute some kind of instruction code, or a hardware mechanism that automatically transmits the request to the mutual address translation unit 105a according to the designated address may be provided in the processor 103a.

Next, the processor 103a reads out the request, which is from the host machine transmitted from the protocol chip 101a, from the memory 104a and starts the processing (2203). The flow of processing from the sequence 2203 to the sequence 2210 in which the processor 103a generates a Write response and stores the Write response in the memory 104a is the same as the flow of processing from the sequence 302 to the sequence 309 in FIG. 3 of the first embodiment.

In the fifth embodiment, the processor 103a generates a Write response and stores the Write response in the memory 104a in the sequence 2210, then duplicates the Write response, transmits the Write response to the processor 103b through the mutual address translation units 105a and 105b, and stores the Write response in the memory 104b (2211).

By doing so, after the processor 103b subsequently transitions to the second processing mode, the processor 103b can identify a case where the Write request from the host machine transmitted by the processor 103a from the protocol chip 101a is stored, but the Write response of the result of processing the request from the host machine is not stored, by retrieving the content of the memory 104b.

The processor 103a duplicates the Write response in the sequence 2211, stores the Write response in the memory 104b of the processor 103b, generates a response notification notifying the protocol chip 101a that the v response has been stored in the memory 104a, and transmits the response notification to the protocol chip 101a via the memory address translation unit 102a (2212).

The flow of processing from the sequence 2212 to the sequence 2221 in which the processor 103a reads out the data store completion response stored in the storage device 107a from the memory 104a and checks it is the same as the flow of processing from the sequence 310 to the sequence 319 in FIG. 3 of the first embodiment. With the above flow of processing, the processing sequence in the case of receiving the Write request from the host machine is completed in the fifth embodiment.

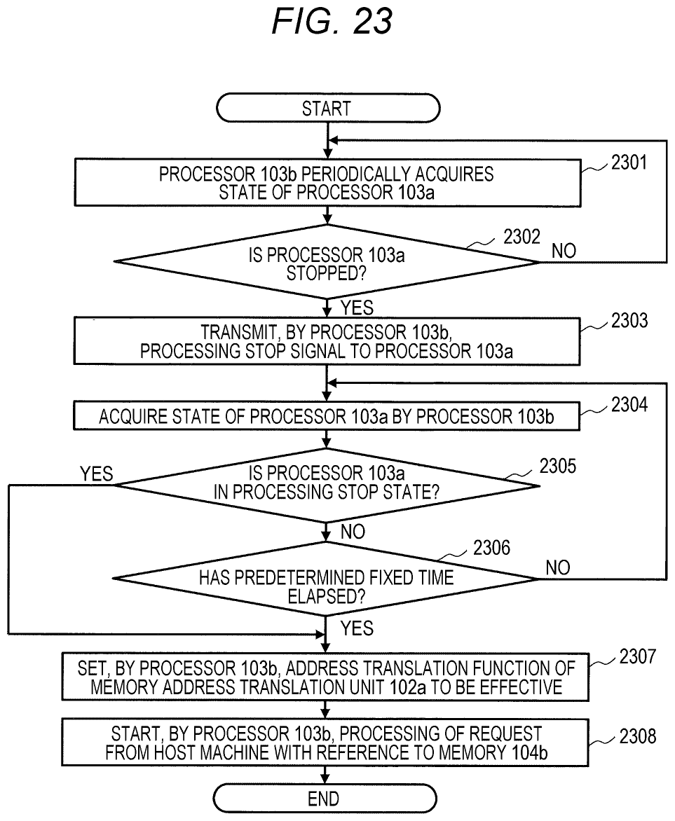

Next, an example of processing for switching from the first processing mode to the second processing mode in the fifth embodiment will be described with reference to FIG. 23.

FIG. 23 illustrates an example of a process of switching from a first processing mode in which a processor included in the same controller as the one which includes the protocol chip processes a Read request and a Write request received by the protocol chip from the host machine to a second processing mode in which a processor included in a controller different from the one which includes the protocol chip processes a Read request and a Write request received by the protocol chip from the host machine in the fifth embodiment.

In the fifth embodiment, in the first processing mode, the processor 103a included in the same controller 110a as the one which includes the protocol chip 101a stores the request from the host machine and the response of the result of processing the request from the host machine in the memory 104a of the processor 103a, and also stores each copy in the memory 104b of the processor 103b included in the controller 110b different from the one which includes the protocol chip 101a.

In the second processing mode, since the processor 103b performs processing with reference to the memory 104b, the process of storing the copy into the memory 104b by the processor 103a as described above needs to be completely stopped, that is, the processing of the processor 103a needs to be completely stopped. If the operation of the processor 103a is not completely stopped and the process of storing the copy into the memory 104b is continued, a conflict occurs with the processor 103b that performs the processing with reference to the memory 104b, and the processor 103b may malfunction.

Therefore, in the example of the process of switching from the first processing mode to the second processing mode described in FIG. 23, it is confirmed that the operation of the processor 103a is completely stopped. For this purpose, the processor 103b generates a particularly determined processing stop signal and transmits the processing stop signal to the processor 103a, and transmits the processing stop signal to the processor 103a. After confirming whether the processor 103a is in the processing stop state for a certain period of time, the processor 103b enables the address translation function of the memory address translation unit 102a and transitions to the second processing mode.

Hereinafter, in FIG. 23, it is assumed that the storage system 1 is in the first processing mode as an initial state, and the request from the host machine received by the protocol chip 101a is processed by the processor 103a included in the same controller 110a as the one which includes the protocol chip 101a.

In FIG. 23, when the storage system 1 is in the first processing mode, the processor 103b included in the controller 110b different from the one which includes the protocol chip 101a periodically acquires the state of the processor 103a included in the same controller 110a as the one which includes the protocol chip 101a (step 2301).

Then, in step 2302, the processor 103b determines whether the processor 103a is stopped. The stop of the processor 103a includes a case where the memory 104a connected to the processor 103a is stopped due to inaccessibility caused by a fault or the like. As a result of the determination, when the processor 103a is operating normally and is not stopped, the process returns to step 2301, and the processor 103b periodically acquires the state of the processor 103a again and repeats the determination in step 2302.

When it is determined that the processor 103a is stopped, the process proceeds to step 2303, and the processor 103b transmits a processing stop signal to the processor 103a. The processing stop signal may be transmitted by providing a particularly dedicated signal line between the processor 103b and the processor 103a, or may be transmitted from the processor 103b through the mutual address translation units 105b and 105a.

In the fifth embodiment, in a case where the processor 103a receives the processing stop signal, there is a processing stop state in which the execution processing of the instruction of the processor is stopped, and the processor transitions to the processing stop state within a certain period of time. Therefore, the processor 103a has a function of automatically transitioning to the processing stop state by hardware in a case where the processing stop signal is received. In addition, even in a case where the processor 103a cannot transition to the processing stop state within a certain period of time even when receiving the processing stop signal due to a fault or the like, it is assumed that the instruction execution processing of the processor is stopped after the certain period of time has elapsed.

In FIG. 23, subsequently, in step 2304, the processor 103b acquires whether the state of the processor 103a is the processing stop state. In step 2305, the processor 103b determines whether the acquired state of the processor 103a is a processing stop state. As a result of the determination, if the current state is the processing stop state, the process proceeds to step 2307.

As a result of the determination, if the current state is not the processing stop state, the process proceeds to step 2306, and it is determined whether a predetermined certain time has elapsed since the transmission of the processing stop signal. If the certain period of time has not elapsed, the process returns to step 2304, and it is acquired whether the state of the processor 103a is changed to the processing stop state again.

In a case where it is determined in step 2305 that the state of the processor 103a is the processing stop state or a certain period of time has elapsed after the processing stop signal is transmitted in step 2306, the process reaches step 2307, and the processor 103b sets the address translation function of the memory address translation unit 102a to be effective and transitions the storage system 1 to the second processing mode.

The effective setting signal of the address translation function of the memory address translation unit 102a may be transmitted from the processor 103b to the memory address translation unit 102a via the mutual address translation units 105b and 105a and the processor 103a illustrated in FIG. 1, or a dedicated signal line for this purpose may be particularly provided between the processor 103b and the memory address translation unit 102a.

Next, in step 2308, the processor 103b starts processing the request from the host machine which is stored in the memory 104b, and stores a response of the result of processing the request from the host machine in the memory 104b.

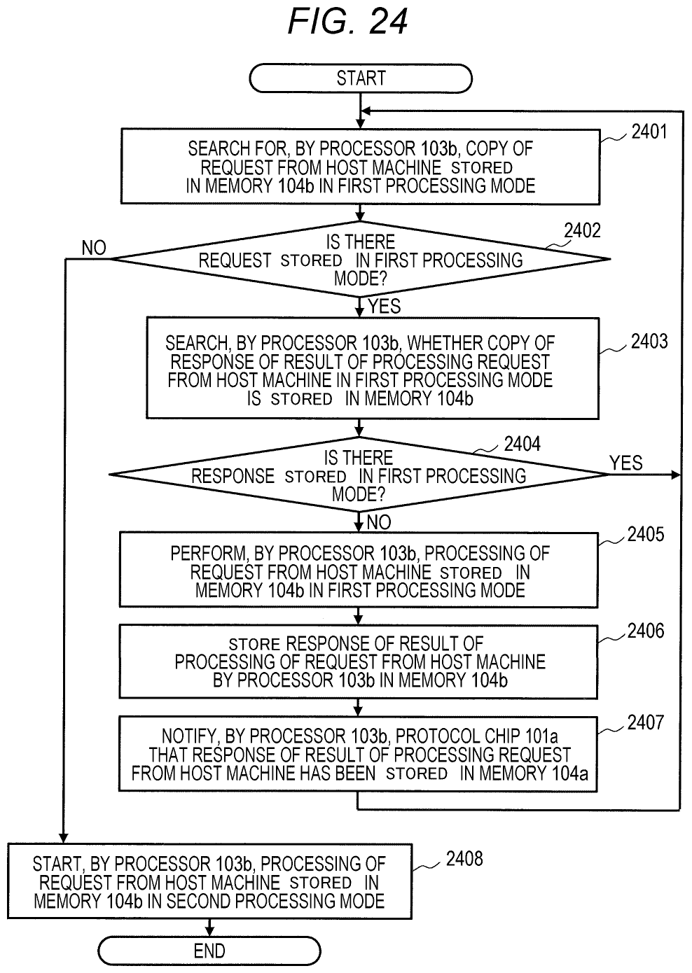

Finally, an example in which the processor 103b processes a copy of a request from the host machine stored in the memory 104b of the processor 103b by the processor 103a after the storage system 1 transitions to the second processing mode in the fifth embodiment will be described with reference to FIG. 24.

In FIG. 24, when transitioning to the second processing mode, the processor 103b searches the memory 104b for a copy of the request from the host machine stored by the processor 103a in the first processing mode (step 2401).

Next, in step 2402, as a result of the search, it is determined whether there is a copy of the request from the host machine stored by the processor 103a in the first processing mode. As a result of the determination, when there is no copy of the request from the host machine stored in the first processing mode by the processor 103a, the process proceeds to step 2408, and in the second processing mode, processing of the request from the host machine stored in the memory 104b of the processor 103b is newly started from the protocol chip 101a through the memory address translation unit 102a, the processor 103a, and the mutual address translation units 105a and 105b. The processing sequence of the request from the host machine in the second processing mode is the same as the processing sequence described in FIGS. 4 and 5 of the first embodiment.

In a case where it is determined in step 2402 that there is a copy of the request from the host machine stored by the processor 103a in the first processing mode, the process proceeds to step 2403, and the processor 103b further searches the memory 104b for a copy of the response of the result of processing the request from the host machine stored by the processor 103a in the first processing mode. In step 2404, when there is a copy of the response of the result of processing the request from the host machine, the process returns to step 2401, and further, the search is continued as to whether the request from the host machine stored by the processor 103a in the first processing mode exists in the memory 104b.

In step 2404, if there is no copy of the response of the result of processing the request from the host machine, the process proceeds to step 2405, and the processor 103b processes the request from the host machine. Further, in step 2406, the processor 103b stores a response of the result of processing the request from the host machine in the memory 104b, and in step 2407, notifies the protocol chip 101a that the response of the result of processing the request from the host machine has been stored in the memory 104b, and returns the response to the host machine.

The sequence of processing the request from the host machine from step 2405 to step 2407 and causing the protocol chip 101a to return the response of the processed result to the host machine is the same as the processing sequence described in FIGS. 4 and 5 in the first embodiment except that the request from the host machine is first stored in the memory 104b. That is, if the request from the host machine is a Read request, the sequence is the same as the sequence 402 and subsequent sequences of FIG. 4 of the first embodiment, and if the request from the host machine is a Write request, the sequence is the same as the sequence 502 and subsequent sequences of FIG. 5 of the first embodiment.

In step 2407, after the processing of the request from the host machine is completed, the response of the processed result is provided in notification to the protocol chip 101a and returned to the host machine, the process returns to step 2401, and the processor 103a continues searching whether the request from the host machine stored in the first processing mode is in the memory 104b.

As described above, when the storage system 1 transitions from the first processing mode to the second processing mode, the processor 103a stores the request from the host machine transmitted from the protocol chip 101a in the memory 104a. However, in a case where the processing of the request from the host machine is not completed and the response of the result of processing the request from the host machine cannot be stored in the memory 104a, the processor 103b processes the request from the host machine by copying the request from the host machine stored in the memory 104b, notifies the protocol chip 101a of the response of the result of the processing, and returns the response to the host machine, so that the processing can be completed.

Note that the present invention is not limited to the above-described embodiments, and various modifications are included. For example, the above-described embodiments have been described in detail for easy understanding of the present invention and are not necessarily limited to those having all the described configurations. In addition, a part of the configuration of a certain embodiment can be replaced with the configuration of another embodiment, and the configuration of another embodiment can be added to the configuration of a certain embodiment. It is possible to add, delete, and replace other configurations for a part of the configuration of each embodiment.

Each of the above-described configurations, functions, processing units, and the like may be realized by hardware by designing a part or all of them with, for example, an integrated circuit. In addition, each of the above-described configurations, functions, and the like may be realized by software by a processor interpreting and executing a program for realizing each function. Information such as a program, a table, and a file for implementing each function can be stored in a recording device such as a memory, a hard disk, and an SSD, or a recording media such as an IC card or an SD card.

Further, control lines and information lines are described in consideration of necessity for the description, and all control lines and information lines in the product are not necessarily described. It may be considered that almost all the components are connected to each other in actual.

What is claimed is:

1. A storage system that is connected to a host machine and stores/outputs data according to a request from the host machine, the storage system comprising:
a plurality of controllers, wherein
a first controller of the plurality of controllers includes:
a first protocol chip that is connected to the host machine and performs protocol processing of data transmission with the host machine;
a first processor that controls the storage system; and
a first memory that is connected to the first processor and stores data necessary for controlling the storage system,
a second controller different from the first controller among the plurality of controllers includes:
a second processor that controls the storage system; and
a second memory that is connected to the second processor and stores data necessary for controlling the storage system,
the storage system further includes a mutual address translation unit that mutually translates an address used by the first processor and an address used by the second processor,
processing modes of the storage system includes a first processing mode and a second processing mode,
in the first processing mode,
the first protocol chip stores a request received from the host machine in the first memory,
the first processor processes the request from the host machine stored in the first memory, and stores a response of a result of processing the request from the host machine in the first memory, and
the first protocol chip reads out, from the first memory, the response of the result of processing the request from the host machine, and transmits the response to the host machine, and
in the second processing mode,
the first protocol chip stores a request received from the host machine in the second memory through the mutual address translation unit,
the second processor processes the request from the host machine stored in the second memory, and stores a response of a result of processing the request from the host machine in the second memory, and
the first protocol chip reads out, from the second memory, the response of the result of processing the request from the host machine through the mutual address translation unit and transmits the response to the host machine.

2. The storage system according to claim 1, wherein
the first protocol chip uses an address indicating the first memory among addresses used by the first processor so as to store a request from the host machine in the first memory and read out, from the first memory, a response of a result of processing a request from the host machine,
the first controller includes a first memory address translation unit, and
the first memory address translation unit translates an address used by the first protocol chip indicating the first memory among addresses used by the first processor into an address indicating the second memory among addresses used by the first processor so as to store a request from the host machine in the second memory through the mutual address translation unit and read out, from the second memory, a response of a result of processing a request from the host machine through the mutual address translation unit in the second processing mode.

3. The storage system according to claim 2, wherein
the second controller includes a second protocol chip that is connected to the host machine and performs protocol processing of data transmission with the host machine,
processing modes of the storage system includes a third processing mode and a fourth processing mode,
in the third processing mode,
the second protocol chip stores a request received from the host machine in the second memory,
the second processor processes the request from the host machine stored in the second memory, and stores a response of a result of processing the request from the host machine in the second memory, and
the second protocol chip reads out, from the second memory, the response of the result of processing the request from the host machine, and transmits the response to the host machine,
in the fourth processing mode,
the second protocol chip stores a request received from the host machine in the first memory through the mutual address translation unit,
the first processor processes the request from the host machine stored in the first memory, and stores a response of a result of processing the request from the host machine in the first memory,
the second protocol chip reads out, from the first memory, the response of the result of processing the request from the host machine through the mutual address translation unit and transmits the response to the host machine, and
the second protocol chip uses an address indicating the second memory among addresses used by the second processor so as to store a request from the host machine in the second memory and read out, from the second memory, a response of a result of processing a request from the host machine,
the second controller includes a second memory address translation unit,
the second memory address translation unit translates an address used by the second protocol chip indicating the second memory among addresses used by the second processor into an address indicating the first memory among addresses used by the second processor so as to store a request from the host machine in the first memory through the mutual address translation unit and read out, from the first memory, a response of a result of processing a request from the host machine through the mutual address translation unit in the fourth processing mode, and
the mutual address translation unit is connected to the first memory address translation unit and the second memory address translation unit.

4. The storage system according to claim 1, wherein
in the first processing mode, the first protocol chip uses an address indicating the first memory among addresses used by the first processor so as to store a request from the host machine in the first memory and read out a response of a result of processing a request from the host machine from the first memory, and
in the second processing mode, the first protocol chip uses an address indicating the second memory among addresses used by the first processor so as to store a request from the host machine in the second memory through the mutual address translation unit and read out a response of a result of processing a request from the host machine from the second memory through the mutual address translation unit.

5. The storage system according to claim 4, wherein
the second processor is further configured for transition to the second processing mode to execute in the first processing mode:
transmitting, to the first protocol chip, an instruction to stop storing a request from the host machine in the first memory;
changing, in the first protocol chip, a storing destination of a request from the host machine and a read-out source of a response of a result of processing a request from the host machine from the first memory to the second memory; and
transmitting, to the first protocol chip, an instruction to start storing a request from the host machine in the second memory.

6. The storage system according to claim 1, wherein
in the first processing mode, the first processor is configured to execute:
reading out, from the first memory, a request from the host machine;
storing, in the second memory through the mutual address translation unit, information for notifying the host machine that processing of a request from the host machine has been stopped for a preparation of a case where processing of the request from the host machine is stopped;
in a case where processing of the request from the host machine has not been stopped,
storing a response of a result of processing the request from the host machine in the first memory; and
storing, in the second memory through the mutual address translation unit, information indicating that the response of the result of processing the request from the host machine has been stored in the first memory, and
in the second processing mode, the second processor is configured to execute, in a case where processing of a request from the host machine is stopped;
reading out, from the second memory, information for notifying the host machine that processing of the request from the host machine has been stopped; and
transmitting, to the first protocol chip, an instruction to transmit, to the host machine, information for notifying the host machine that processing of the request from the host machine has been stopped.

7. The storage system according to claim 2, wherein
the first memory address translation unit is configured to execute: in the first processing mode,
duplicating a request from the host machine stored by the first protocol chip in the first memory; and
storing the duplicated request in the second memory through the mutual address translation unit.

8. The storage system according to claim 7, wherein
the second processor detects that processing of the first processor is completely stopped, and
the second processor changes processing of the storage system from the first processing mode to the second processing mode.

9. The storage system according to claim 3, wherein
the first controller includes a first interface unit and a first processor board unit,
the first interface unit includes the first protocol chip and the first memory address translation unit,
the first processor board unit includes the first processor and the first memory,
the second controller includes a second interface unit and a second processor board unit,
the second interface unit includes the second protocol chip and the second memory address translation unit,
the second processor board unit includes the second processor and the second memory,
the first processor board unit is configured to be replaceable independently of the first interface unit,
during replacement of the first processor board unit, a request from the host machine received by the first protocol chip is stored in the second memory according to the second processing mode, and a response of a result of processing a request from the host machine received by the first protocol chip is read out from the second memory by the first protocol chip,
the second processor board unit is configured to be replaceable independently of the second interface unit,
during replacement of the second processor board unit, a request from the host machine received by the second protocol chip is stored in the first memory according to the fourth processing mode, and a response of a result of processing a request from the host machine received by the second protocol chip is read out from the first memory by the second protocol chip.
